(19) United States
(12) Patent Application Publication
(10) Pub. No.: US 2026/0362013 A1
(43) Pub. Date: Nov. 12, 2026

(54) METHOD AND SYSTEM FOR TARGET SEARCH AND AUTONOMOUS GUIDANCE USING PAN-TILT-ZOOM CAMERA ON AUTONOMOUS MOBILE PLATFORM

(71) Applicant: SOLOMON TECHNOLOGY CORPORATION, Taipei City (TW)

(72) Inventors: Cheng-Lung CHEN, Taipei City (TW); Xuan Loc NGUYEN, Taipei City (TW); Tsung-Cheng LAI, Taipei City (TW); Tafjira Nugraha BRILIAN, Taipei City (TW); Peng-Yan SIE, Taipei City (TW)

(21) Appl. No.: 19/747,314

(22) Filed: Jul. 20, 2026

Related U.S. Application Data
(63) Continuation-in-part of application No. 19/444,744, filed on Jan. 9, 2026.
Application No. 19/444,744 is a continuation-in-part of application No. 18/781,664, filed on Jul. 23, 2024, now Pat. No. 12,639,855.

(30) Foreign Application Priority Data
Apr. 3, 2024 (TW) 113112669

(51) Int. Cl. H04N 23/695; G05D 1/246; G05D 1/689; G06V 10/764; G06V 10/82; H04N 23/60; H04N 23/61; H04N 23/69; H04N 23/698

(52) U.S. Cl. CPC H04N 23/695; G05D 1/2465; G05D 1/689; G06V 10/764; G06V 10/82; H04N 23/61; H04N 23/64; H04N 23/69; H04N 23/698

(57) ABSTRACT

A method and system for target search and autonomous guidance on an autonomous mobile platform that transforms uncertain visual observations into progressively refined spatial guidance and verified target acquisition. The autonomous mobile platform performs hierarchical search using a PTZ camera, converts image-space observations into a bounded spatial uncertainty region in a three-dimensional SLAM coordinate system, and navigates toward a waypoint derived from the spatial uncertainty region. During approach, the autonomous mobile platform iteratively refines the spatial uncertainty region according to a geometrically structured reduction criterion using controlled perception and platform motion, with PTZ control actions selected to reduce spatial uncertainty. Sensor handoff confirmation transitions sensing from the PTZ camera to secondary sensors while maintaining cross-sensor identity consistency for verified arrival. Arrival is determined through a multi-stage protocol requiring successful sensor handoff and satisfaction of arrival confirmation conditions.

### CROSS-REFERENCE TO RELATED APPLICATION

This application is a continuation-in-part of U.S. patent application Ser. No. 19/444744, filed on Jan. 9, 2026, which is a continuation-in-part of U.S. patent application Ser. No. 18/781664, filed on Jul. 23, 2024, which claims priority to Taiwanese Invention Patent Application No. 113112669, filed on Apr. 3, 2024. The aforesaid applications are incorporated by reference herein in their entirety.

### FIELD

The disclosure relates to a method and a system for target search and autonomous guidance using a pan-tilt-zoom (PTZ) camera on an autonomous mobile platform. More specifically, the disclosure relates to techniques for using a PTZ camera to detect and locate distant targets in an unstructured environment, and for guiding an autonomous mobile platform toward a detected target while maintaining visual contact with the detected target and confirming arrival through multi-sensor handoff.

### BACKGROUND

Existing pan-tilt-zoom (PTZ) camera systems mounted on mobile robots have proven effective for specific tasks such as reading meters at known locations or monitoring fixed points in an environment. However, these systems suffer from a critical limitation: they are inherently reactive rather than proactive. The operator or control system must know the approximate location of the target object before the PTZ camera can be directed to image it. In scenarios where the target location is initially unknown and the target object must be actively searched for and localized in an expansive environment, conventional PTZ systems provide no integrated capability for such target discovery.

Autonomous mobile robots and platforms typically employ SLAM (Simultaneous Localization and Mapping) algorithms to navigate through unstructured environments by building and maintaining semantic maps. These platforms usually rely on fixed-field-of-view cameras for visual perception. While a wide-angle camera provides a large field of view for obstacle detection and localization, it has an inherent limitation in resolving distant objects. The angular resolution of a fixed wide-angle camera at long ranges is insufficient to clearly identify targets that are hundreds of meters away.

Modern computer vision has advanced significantly in the field of object detection and classification. Deep learning-based models can detect objects with high accuracy. However, integrating these deep learning-based models into an active target acquisition system on a mobile platform has not been systematically addressed.

Even when a target object has been detected and identified in a PTZ image, determining the three-dimensional location of the target in the robot's environment presents a challenge.

### SUMMARY

The present disclosure provides a method and system for target search and autonomous guidance using a pan-tilt-zoom camera on an autonomous mobile platform. According to the disclosure, the system converts image-space observations into a bounded spatial uncertainty region that is iteratively reduced through controlled perception and platform motion to guide an autonomous mobile platform toward a target with verified arrival. In this way, target identification serves as an input to an uncertainty-bounded guidance loop rather than as an endpoint in itself.

In one aspect, a method for target search and autonomous guidance is provided. The method is implemented by a processing unit of an autonomous mobile platform. The autonomous mobile platform includes a camera module configured as a pan-tilt-zoom camera, a range imaging module (such as a LiDAR sensor, an RGB-D sensor, or a Time-of-Flight senor), at least one secondary sensor configured for close-range confirmation, an actuating module, and the processing unit.

The processing unit receives a search task containing at least a target description specifying a target object to be found. The search task may be triggered by multiple sources including: an active user search command via a natural language input, a scheduled periodic task retrieved from a task schedule stored in a memory of the autonomous mobile platform, a dispatch received from an upstream controller (such as a cloud server or a fleet management system) via a communication module of the autonomous mobile platform, or a voice command processed through speech-to-text and natural language understanding.

The processing unit executes a hierarchical search procedure that includes two stages: a coarse search stage and a fine identification stage. In the coarse search stage, the processing unit controls the PTZ camera to perform a panoramic sweep of the environment at a wide-angle setting. An object detection model configured for real-time execution on an edge-processing device is applied to each sweep image to detect candidate objects. In the fine identification stage, for each candidate object, the processing unit controls the PTZ camera to zoom in on the candidate object to capture an enlarged image of the candidate object. One or more target identification methods are then applied by the processing unit to the enlarged image.

It should be noted that four coordinate systems are used in the disclosure, including 1) an image coordinate system (a 2D pixel coordinate system of (u, v)), 2) a camera coordinate system (a 3D coordinate system centered at the camera optical center), 3) a platform coordinate system (a local 3D coordinate system with a body of the autonomous mobile platform being an origin of this coordinate system), and 4) a SLAM coordinate system (a global 3D coordinate system used by the SLAM algorithm). Upon identifying the target object from among the candidate objects based on the target identification method, the processing unit obtains a bounding box that includes a plurality of bounding box coordinates of the target object in the PTZ image. The processing unit then projects the bounding box into a SLAM coordinate system using uncertainty cone projection. Specifically, projection rays are computed for at least four corners of the bounding box using a camera intrinsic matrix K and current PTZ angles (i.e., a pan angle and a tilt angle). Each corner pixel (u_i, v_i) yields an unnormalized ray direction in a camera coordinate system (i.e., a camera frame): r_cam_i=K_inverse multiplied by a homogeneous pixel coordinate [u_i, v_i, 1] transposed. A normalized unit direction vector is then obtained as d_cam_i=r_cam_i/∥r_cam_i∥. The projection ray is then rotated to a platform coordinate system using PTZ rotation matrices: d_platform_i=R_tilt(theta_tilt) multiplied by R_pan(theta_pan) multiplied by d_cam_i. The projection ray is then transformed to the SLAM coordinate system: d_world_i=R_body multiplied by d_platform_i, where R_body is the rotation component of a pose of the autonomous mobile platform from a SLAM algorithm. These four projection rays define an uncertainty cone in three-dimensional space. The uncertainty cone is bounded by one or more depth limits to form a frustum-like uncertainty volume in which the target object is estimated to be located. Unlike single-ray or center-point one-shot localization approaches, the disclosed method constructs a bounded geometric uncertainty region from image-space observations and uses subsequent observations and platform motion to iteratively refine the spatial uncertainty region. The SLAM algorithm provides a reference of the pose of the autonomous mobile platform for transforming projected observation points into the SLAM coordinate system, while the spatial uncertainty region remains a separate construct derived from image-space geometry (based on the enlarge image) rather than an uncertainty output of the SLAM algorithm. The centroid of this volume (i.e., the spatial uncertainty region) serves as a candidate navigation waypoint; the actual waypoint may be selected as the centroid, a nearest traversable point within or relative to the spatial uncertainty region, a point maintaining line-of-sight from the autonomous mobile platform to the target object, or a task-specific approach pose, depending on environment constraints and mission requirements.

The processing unit determines a navigation path toward a waypoint derived from the spatial uncertainty region using path planning algorithms on a semantic 3D map.

The processing unit controls the actuating module to move the autonomous mobile platform along the navigation path while iteratively re-acquiring the target object. At each increment, the PTZ camera is directed toward an expected target direction, a new image is captured, the target object is re-detected, the bounding box is updated, and the spatial uncertainty region is refined by computing U_new intersecting with U_previous, where U_refined=U_new intersection U_previous. If the intersection is empty or below a minimum overlap criterion, the processing unit may use a union with confidence weighting, relax one or more depth or angular thresholds, retain the higher-confidence region, or revert to a re-search procedure described herein.

A sensor handoff confirmation is performed as the autonomous mobile platform approaches. The sensor handoff confirmation is initiated when the estimated target distance from the autonomous mobile platform to the target object (d_target) falls below a handoff range threshold (d_handoff). The processing unit attempts detection of the target object using at least one secondary sensor. The sensor handoff is confirmed when a target representation in the secondary sensor meets one or more threshold conditions selected from: a target-occupancy threshold, a detection-confidence threshold, an OCR-readability threshold, a barcode-decodability threshold, a point-cloud-density threshold, a target-distance-consistency threshold, an identity-consistency threshold requiring correspondence between the PTZ-based target representation and the secondary-sensor representation, or a task-specific quality threshold.

The processing unit determines arrival of the autonomous mobile platform to the target object through a two-stage protocol. In the first stage, while in an APPROACHING state, one or more pre-arrival trigger conditions are evaluated. The pre-arrival trigger conditions include the bounding box of the target object occupying at least a threshold percentage of the image frame, an estimated distance to the target object falls below a proximity threshold, or a secondary sensor begins to register the target object. When at least one pre-arrival trigger condition is met, the processing unit transitions to a VERIFYING state. In the second stage, while in the VERIFYING state, the processing unit performs sensor handoff confirmation as described herein. An ARRIVED state is entered when sensor handoff confirmation is successful and one or more arrival confirmation conditions are satisfied, where the arrival confirmation conditions are selected from: (i) a target-occupancy condition requiring the bounding box of the target object to occupy at least a threshold percentage of the image frame of the camera module, (ii) a sensor-confirmation condition requiring at least one secondary sensor to have detected the target object and to have met a corresponding threshold condition for the downstream task, (iii) a distance condition requiring the estimated distance from the autonomous mobile platform to the target object is less than a distance threshold, or (iv) a combined condition requiring at least two of conditions (i) through (iii) to be simultaneously satisfied.

The method includes dynamic re-search capability. If during approach of the autonomous mobile platform to the target object, the processing unit fails to re-detect the target object for a maximum number of consecutive re-acquisition attempts, the target object is considered lost. The processing unit records a last known position of the target object, and transitions to a re-search mode.

In another aspect, an autonomous mobile platform system includes a processing unit, a camera module (e.g., a PTZ camera), a range imaging module, at least one secondary sensor configured for close-range confirmation, and an actuating module configured to move the autonomous mobile platform, where the processing unit is configured to implement the above mentioned method. In some embodiments, the range imaging module and the secondary sensor may be implemented by separate sensors or by a shared sensor subsystem operating in different modes.

In yet another aspect, a method for multi-modal target identification is provided in which outputs of at least two identification methods are fused to determine whether a candidate object should enter an uncertainty-bounded guidance loop. The identification methods may be selected from trained deep learning classification, reference image matching, Vision Language Model matching, and few-shot learning. In some embodiments, the resulting fused identification output is used as an input for generating a spatial uncertainty region, iterative uncertainty reduction during re-acquisition, and sensor handoff confirmation for downstream target confirmation and navigation.

In a further aspect, a method for uncertainty-bounded guidance is provided, involving generating a bounded spatial uncertainty region in a SLAM coordinate system by projecting an image-based representation of a target into three-dimensional space, iteratively refining the spatial uncertainty region according to a geometrically structured reduction criterion, updating a navigation waypoint based on the refined spatial uncertainty region, performing sensor handoff confirmation when a proximity condition associated with the spatial uncertainty region is satisfied, and determining arrival of the autonomous mobile platform to the target object when sensor handoff confirmation is successful and at least one arrival confirmation condition is satisfied.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an architecture of an autonomous mobile platform configured to perform target search and autonomous guidance.

FIG. 2 is a flowchart illustrating a method for target search and autonomous guidance.

FIG. 3 is a flowchart illustrating a hierarchical search procedure that includes a coarse search stage and a fine identification stage.

FIG. 4 is a flow chart illustrating steps of the projection of a bounding box from a PTZ image in an image coordinate system to an uncertainty cone in a SLAM coordinate system.

FIG. 5 is a flowchart illustrating a guidance and approach procedure with iterative re-acquisition and sensor handoff confirmation.

FIG. 6 is a state machine diagram with multiple states, including an IDLE state, a SEARCH state, a DETECTED state, an APPROACHING state, a RE-SEARCH state, a VERIFYING state, an ARRIVED state, and an EXECUTING state, with transitions and error handling.

FIG. 7 is a flowchart illustrating a dynamic re-search procedure executed when a target is lost during the APPROACHING state.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

The following detailed description provides embodiments and implementations of a method and a system for target search and autonomous guidance using a PTZ (pan-tilt-zoom) camera on an autonomous mobile platform. The description is organized into sections covering system architecture, search task triggers, hierarchical search procedures, uncertainty modeling, navigation and approach methods, sensor handoff, arrival determination, state management, and additional embodiments. As used herein, a “spatial uncertainty region” is a primary uncertainty construct used for target guidance, and an “uncertainty cone” and an “uncertainty volume” refer to specific implementations or representations of the primary uncertainty construct. A “candidate representation” or a “candidate region” refers to a region representation selected from a bounding box, a segmentation mask, a polygon, a contour, a cropped image region, a keypoint-associated region, or another region representation suitable for identification and control. As used herein, the following terminology hierarchy applies to the uncertainty modeling: the “uncertainty cone” refers to an angular domain or a frustum-like geometry defined by the projection rays from the bounding box corners; the “uncertainty volume” refers to a three-dimensional volume obtained when the uncertainty cone is bounded by near and far depth limits; and the “spatial uncertainty region” or the “uncertainty region” is a general term that may refer to either the uncertainty volume or the candidate region on a semantic map.

Some prior approaches have attempted to address three-dimensional uncertainty arising from two-dimensional camera observations. In one example, a naive approach would be to use ray-based localization: the center of the detected object in the PTZ image defines a ray in a three-dimensional space, and the intersection of this ray with depth measurements from a LiDAR (light detection and ranging) or RGB-D (red-green-blue-depth) sensor could potentially yield a target location. However, this approach is subject to significant error sources. The pose of the robot in the SLAM map may have accumulated error. The bounding box of the detected object spans multiple pixels, introducing angular uncertainty. These small pose errors are magnified at long range: an angular error of one degree at a distance of 100 meters results in a lateral error of 1.7 meters. Existing systems do not systematically model and propagate these uncertainties through the localization pipeline. In another example, multi-camera triangulation systems have been proposed that define a three-dimensional line of probability for each camera and estimate a target reference point by pseudo-intersection of these probability lines. However, such approaches rely on multiple fixed cameras at known positions and are inherently unsuitable for a single PTZ camera mounted on a mobile platform whose pose changes continuously during navigation. The fixed-camera assumption eliminates the need for dynamic rotation matrices and SLAM-based pose estimation, which are essential when the camera platform itself is in motion. Other approaches have employed camera intrinsic matrices and extrinsic transformation matrices to project bounding box corners between image coordinates and three-dimensional space for the purpose of three-dimensional object detection. While this work demonstrates the mathematical framework of projecting bounding box corners through intrinsic and extrinsic camera parameters, it addresses the inverse problem of detecting three-dimensional objects from images rather than projecting two-dimensional detection uncertainty into a three-dimensional volume for autonomous navigation. Furthermore, these detection-oriented systems do not incorporate pan-tilt-zoom rotation matrices, do not iteratively refine the uncertainty volume through sequential observations from different viewpoints, and do not integrate with SLAM pose estimation for mobile platform guidance.

Recent advances in vision-language models and few-shot learning have shown promise for robotic target identification. Frameworks such as Proto-CLIP have demonstrated the integration of vision-language prototypical networks with few-shot learning capabilities on robotic platforms, achieving zero-shot and few-shot object recognition through CLIP-based embeddings. Similarly, systems such as ClipRover have applied CLIP-based reasoning for autonomous exploration and target discovery on mobile robots. However, these approaches typically rely on a single identification modality or a narrow combination of techniques, and do not provide a comprehensive multi-modal fusion protocol that systematically combines deep learning classification (CNN, convolutional neural network, or ViT, vision transformer), reference image matching (using feature descriptors such as SIFT (Scale-Invariant Feature Transform), ORB (Oriented FAST and Rotated BRIEF), or SURF (Speeded-Up Robust Features) with geometric verification such as RANSAC (Random Sample Consensus)), vision-language model matching, and few-shot learning into a unified confidence score fusion framework. The absence of such a comprehensive fusion protocol limits the robustness and reliability of target identification, particularly in challenging environments where any single identification method may fail.

Furthermore, active vision research has explored the use of pan-tilt camera mechanisms for directing visual attention to informative regions of the environment to improve mobile robot localization. While these active perception strategies demonstrate the value of directed sensing on mobile platforms, they focus on landmark selection for pose improvement rather than on iterative target acquisition through sequential uncertainty volume refinement. No prior system has combined PTZ-based uncertainty cone projection with sequential intersection refinement, multi-modal AI identification fusion, formalized sensor handoff confirmation, and a two-stage arrival determination protocol into an integrated autonomous target search and guidance architecture.

A critical gap in the state of the art is the absence of an integrated methodology for transitioning a mobile platform from using a PTZ camera for long-range target detection to using close-range sensors (RGB-D, LiDAR, thermal, ultrasonic) for final verification and action execution. Existing systems typically treat these sensor modalities as separate, requiring manual switching or ad-hoc logic to determine when to engage secondary sensors. There is no systematic framework for performing sensor handoff confirmation.

In some embodiments, one or more trained models may be used, including by way of non-limiting example object-detection models, visual-language models, matching models, or few-shot models. The present disclosure is not limited to any particular model family; the inventive contribution lies in the closed-loop active-perception and target-acquisition architecture integrating PTZ search, uncertainty-bounded localization, autonomous guidance, and sensor handoff confirmation.

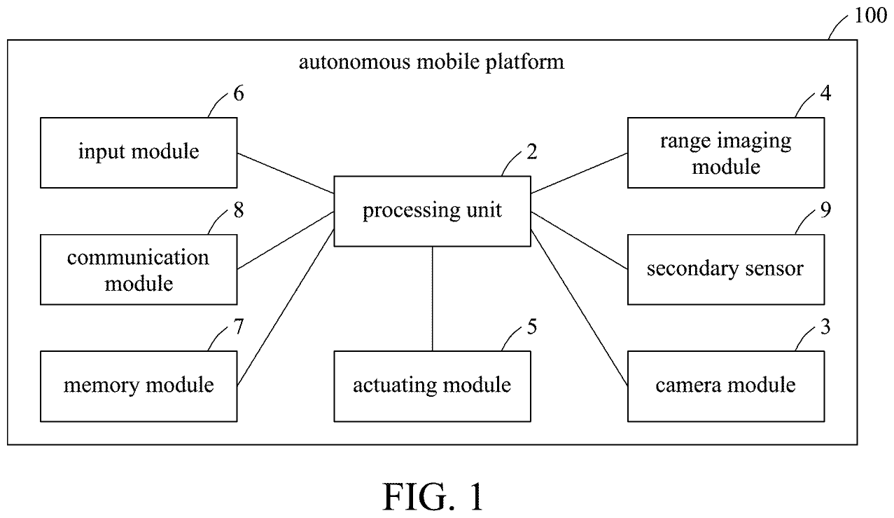

Referring to FIG. 1, according to an embodiment of the disclosure, an autonomous mobile platform 100 includes a processing unit 2, a camera module 3, a range imaging module 4, an actuating module 5, an input module 6, a memory module 7, a communication module 8, and at least one secondary sensor 9 (also referred to as “supplementary sensor” or “close-range sensor”) that is configured for close-range confirmation (or close-range detection). The processing unit 2 is electrically connected to the camera module 3, the range imaging module 4, the actuating module 5, the input module 6, the memory module 7, the communication module 8 and the at least one secondary sensor 9. The secondary sensor 9 may be selected from an RGB-D (red-green-blue-depth) sensor, a LiDAR (light detection and ranging) sensor, a thermal infrared sensor, an ultrasonic sensor, or a close-range imaging sensor. In some embodiments, the range imaging module 4 and the secondary sensor 9 may be implemented by separate sensor hardware or by a shared sensor subsystem operating in different modes or ranges.

The processing unit 2 is the computational core of the autonomous mobile platform 100 and is configured to execute algorithms and to make control decisions for the autonomous mobile platform 100. The processing unit 2 may include a CPU (Central Processing Unit), a GPU (Graphics Processing Unit), a TPU (Tensor Processing Unit), or combinations thereof. The processing unit 2 runs a SLAM (Simultaneous Localization and Mapping) algorithm, executes a hierarchical search procedure, performs an uncertainty cone projection, computes navigation paths, controls the camera module 3, and determines arrival conditions. In some embodiments, the processing unit 2 includes edge computing hardware (e.g., an edge processing device) disposed locally on the autonomous mobile platform 100. In other embodiments, the processing unit 2 may offload computation-intensive tasks to a cloud server (not shown) via the communication module 8.

The camera module 3 may be a PTZ camera that includes one or more image sensors (such as a CMOS (Complementary Metal-Oxide-Semiconductor) image sensor or a CCD (Charge-Coupled Device) sensor), a motorized pan actuator and a motorized tilt actuator (hereinafter referred to as “motorized pan and tilt actuators”) respectively for rotating the PTZ camera about a vertical axis (Y) (i.e., a tilt axis) and a horizontal axis (X) (i.e., a pan axis), and a variable focal length lens (e.g., a varifocal lens) or a variable zoom mechanism. The motorized pan and tilt actuators are stepper motors, DC (direct current) servo motors, or other actuation mechanisms capable of controlling a pan angle (theta_pan) and a tilt angle (theta_tilt) of the PTZ camera to point at a pointing direction within a specified accuracy (e.g., plus or minus 0.1 degrees from the pointing direction). In some embodiments, the camera module 3 includes multiple lenses with different focal lengths (e.g., a telephoto lens for long-range imaging and a wide-angle lens for panoramic views), with a motorized turret (not shown) selecting which lens is in the optical path. The camera module 3 is configured to capture an image of the environment of the autonomous mobile platform 100 and to output the captured image as digital image data to the processing unit 2 at a specified frame rate (e.g., 10 Hz, 30 Hz).

The range imaging module 4 is configured to provide three-dimensional depth or range measurements of the environment. The range imaging module 4 may be a LiDAR system, an RGB-D camera, or a ToF (Time-of-Flight) camera that respectively provides point cloud data, depth maps, and distance measurements to the processing unit 2. In some embodiments, the range imaging module 4 includes multiple sensors of different types, providing redundancy and complementary information.

The actuating module 5 is configured to move the autonomous mobile platform 100 (e.g., a wheeled robot, a tracked robot, a humanoid robot, an UAV (unmanned aerial vehicle) or an USV (unmanned surface vehicle)) through the environment. For a wheeled robot, the actuating module 5 includes electric motors driving a plurality of wheels of the wheeled robot with differential speed control for steering. For a tracked robot, the actuating module 5 includes motors driving the left and right tracks of the tracked robot independently. For a humanoid robot, the actuating module 5 includes servos and motors controlling the joints of the legs and body of the humanoid robot. For an UAV, the actuating module 5 includes electric motors driving propellers of the UAV. For USVs, the actuating module 5 includes propellers or other water-based propulsion mechanisms. The processing unit 2 is configured to command the actuating module 5 to move the autonomous mobile platform 100 along a computed path (e.g., a navigation path).

The input module 6 is configured to allow the autonomous mobile platform 100 receive commands from users or operators. The input module 6 may include a microphone (not shown) for receiving a voice input, a keyboard (not shown) or touchscreen (not shown) for receiving a textual input (e.g., a natural language text), or a network interface (not shown) for receiving commands from a remote operator. The input module 6 is configured to capture user input and passes the user input to the processing unit 2 for interpretation.

The memory module 7 is configured to store persistent data including intrinsic parameters for the PTZ camera (e.g., a camera intrinsic matrix or distortion coefficients), a plurality of reference images that correspond respectively to a plurality of object categories (i.e., types of object) for target identification, trained AI models for object detection and classification, stored task schedules for periodic execution, and pre-built semantic maps (e.g., a semantic three-dimensional (3D) map). The memory module 7 may include RAM (random access memory) for fast access and persistent storage (e.g., SSD (solid state drive) or hard drive) for long-term data retention. In some embodiments, the memory module 7 may further store example images provided by a user at a start of a search task for few-shot learning model adaptation. The semantic 3D map represents each known object as a 3D bounding box associated with a semantic label, the 3D bounding box being expressed in the SLAM coordinate system. The memory module 7 may further maintain an object list in which each entry corresponds to one of the 3D bounding boxes represented in the semantic 3D map, so as to facilitate semantic queries over the SLAM map.

The communication module 8 is configured to enable the autonomous mobile platform 100 to communicate with external systems including cloud servers, fleet management systems, and other robots. The communication module 8 may include a Wi-Fi transceiver, a 4G/5G cellular modem, an Ethernet controller, or other network interfaces. The communication module 8 is used to receive search tasks dispatched from an upstream controller (e.g., a cloud server, a fleet management system or a fleet controller), to offload computation to cloud services, and to transmit status updates and results back to the upstream controller.

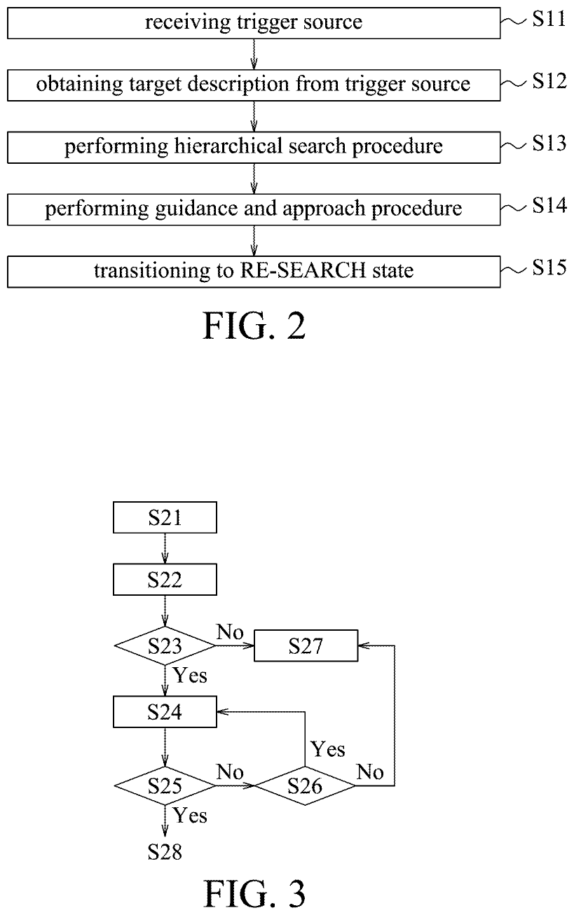

Referring further to FIG. 2, a method for target search and autonomous guidance includes steps S11 to S15. In step S11, the processing unit 2 receives a trigger source, and in step S12, the processing unit obtains a target description from the trigger source. A search task is initiated by the processing unit 2 from one or more trigger sources. Each trigger source provides the target description indicating a target object and optionally an action command indicating an action to be performed by the autonomous mobile platform 100. The processing unit 2 monitors all trigger sources continuously and, when a trigger source related to a search task is received, the processing unit 2 initiates the search task by performing the hierarchical search procedure (step S13) to search for the target object.

A trigger source may be an active user search command (i.e., a user command), where a user directly commands the autonomous mobile platform 100 to search for the target object. The user provides the user input (i.e., the user command) through the input module 6, typically in the form of a natural language command. The processing unit 2 receives and processes the natural language command using natural language understanding, and extracts the target description from the natural language command. In some embodiments, the natural language command is processed by a language model (e.g., a Large Language Model (LLM)) that parses the natural language command and extracts structured information including a target category (which is one of the object categories), a color, and/or location constraints of the target object, and a desired action to the target object.

A trigger source may be scheduled periodic tasks, where search tasks are automatically initiated at predetermined times or intervals. The processing unit 2 may have a task schedule stored in the memory module 7 for retrieving the scheduled periodic tasks. The task schedule specifies times of the search tasks and the processing unit 2 checks a current time against the task schedule at regular intervals and, when a time of one of the search tasks arrives, the processing unit 2 retrieves the task description related to the search task and initiates the search task.

A trigger source may be a dispatch from the upstream controller, where the upstream controller sends a search task to the autonomous mobile platform 100 via the communication module 8. The upstream controller may be managing multiple robots and may dispatch different search tasks to different robots in a fleet based on operational priorities.

A trigger source may be a voice and natural language command (i.e., a voice command), where the user speaks a command that is captured by the input module 6 (e.g., microphone), that is converted to text using speech-to-text processing by the processing unit 2, and that is interpreted using natural language understanding by the processing unit 2 to form a text. A natural language processing module or the LLM then parses the text to extract the target description and any action command related to desired actions to the target object.

Referring further to FIG. 3, the hierarchical search procedure includes sub-steps S21 to S25. After obtaining the target description and optionally any action command from the trigger source, the hierarchical search procedure is performed, which is a two-stage process (including a coarse search stage and a fine identification stage) that efficiently searches the environment for the target object of interest. The hierarchical search procedure balances comprehensive environmental scanning with computational efficiency of long-range identification.

In sub-step S21, in the coarse search stage is performed, where the processing unit 2 controls the camera module 3 to perform a wide-angle panoramic sweep so as to obtain a series of sweep images of the environment. Specifically, the processing unit 2 commands the camera module 3 to adjust to a wide-angle setting for achieving a maximum field of view. The processing unit 2 then commands the motorized pan and tilt actuators to rotate the PTZ camera systematically across the environment to perform a panoramic sweep to capture the series of sweep images. The pan angle may sweep from 0 degrees to 360 degrees while the tilt angle may sweep from −30 degrees to +60 degrees. A pattern of the panoramic sweep may be row-by-row, spiral, or other systematic patterns.

As the sweep images are captured, in sub-step S22, an object detection model configured for real-time execution on an edge-processing device (e.g., the processing unit 2) is applied to each sweep image. The object detection model, such as YOLO (You Only Look Once), SSD (Single Shot Detector), or similar real-time architectures, is used to process each sweep image. Specifically, for each sweep image, the object detection model outputs an object list to include any candidate object (hereinafter referred to as “candidate”) that is detected in the sweep image and bounding box(es) corresponding respectively to the candidate(s). That is to say, if no candidate is detected in the sweep image, the object list will be empty. In sub-step S23, the processing unit 2 determines whether the object list includes any candidate, when it is determined that the object list includes at least one candidate, the flow proceeds to sub-step S24; otherwise, the flow proceeds to step S27. It should be noted that these model names are non-limiting examples; any object detection architecture suitable for real-time inference may be used. For each candidate in the object list, the processing unit 2 records image coordinates of the corresponding bounding box in an image coordinate system, the pan angle and the tilt angle of the PTZ camera at the time the sweep image was captured, and a detection confidence score indicating confidence of detecting an object. The detection confidence score is output by the object detection model and is distinct from the identification confidence score described later in [0052]-[0056].

After completing the panoramic sweep and applying the object detection model to the sweep images, the processing unit 2 has accumulated a plurality of candidates in the object list. The fine identification stage is then performed to process the candidates. In sub-step S24, the processing unit 2 selects one of the candidates in the object list that has not been performed with sub-step S24, and controls the camera module 3 to obtain an enlarged image of the candidate. Specifically, the processing unit 2 commands the PTZ camera to point toward the candidate and to zoom in, computes the pan angle and the tilt angle that would center the candidate when being captured by the PTZ camera in the image and commands the motorized pan and tilt actuators to rotate the PTZ camera to the pan angle and the tilt angle thus computed. Simultaneously, the processing unit 2 increases the focal length of the lens. Once the PTZ camera is pointing toward and zoomed in on the candidate, the enlarged image is captured. The PTZ camera adjustment is selected not only to center the candidate but also to improve observation quality (or observation geometry) for subsequent uncertainty computation, such as by selecting a focal length that balances spatial resolution with field-of-view coverage of the candidate region.

In sub-step S25, to the enlarged image of the candidate that is selected in sub-step S24, the processing unit 2 applies one or more target identification methods to determine whether the candidate matches the target object (i.e., whether the candidate belongs to the object category of the target object). When it is determined that the candidate does not match the target object, the flow proceeds to sub-step S26; otherwise, the candidate is determined to match the target object, the flow proceeds to sub-step S28. In sub-step S26, the processing unit 2 determines whether any candidate in the object list has not been performed with sub-steps S24 to S25, when there is any candidate that has not been performed with sub-steps S24 to S25, the flow returns to sub-step S24; otherwise, the flow proceeds to sub-step S27, where the processing unit 2 determines that no target is found, and may report task failure. For sub-step S25, applying the at least one target identification methods may include obtaining, for each of the object categories, an identification confidence score indicating a probability of the candidate belonging to the object category. In some embodiments, the one or more target identification methods may include applying a trained deep learning classification model (e.g., a pre-trained or fine-tuned convolutional neural network (CNN) or a Vision Transformer model) to the enlarged image to classify the candidate in the enlarged image, but the disclosure is not limited to such. If the object category with a highest probability is identical to the target category and the probability (i.e., the identification confidence score) exceeds an identification confidence threshold (e.g., 0.9 for the classification model probability), the candidate is considered to match the target object (i.e., to belong to the target category). These model architectures are non-limiting examples.

In some embodiments, the one or more target identification methods may include performing a reference image matching. In using the reference image matching, the processing unit 2 extracts visual features from both the enlarged imaged and one of the reference images that corresponds to the target category (based on the target description), that is, obtaining a plurality of first visual features from the enlarged image and a plurality of second visual features from the reference image, and compares the enlarged image to one of the reference images that corresponds to the target category to obtain the identification confidence score for determining whether the candidate matches the reference image (i.e., whether the candidate belongs to the target category). In some embodiments, the determination is performed based on feature correspondence (i.e., correspondence between the first visual features and the second visual features). In some embodiments, the visual feature extraction and comparison is performed using feature descriptor algorithms such as SIFT (Scale-Invariant Feature Transform), SURF (Speeded-Up Robust Features), ORB (Oriented FAST and Rotated BRIEF), or deep learning-based feature extractors, but the disclosure is not limited to such. The processing unit 2 further performs feature matching and assesses quality of the comparison using RANSAC (Random Sample Consensus). The identification confidence score may be derived from, for example, a number of RANSAC inliers or another correspondence-based metric. The identification confidence threshold for the reference image matching may be expressed as a minimum inlier count (e.g., at least 20 inliers). These algorithms are non-limiting examples.

In some embodiments, the one or more target identification methods may include inputting the enlarged image and text of the target description to a Vision Language Model (VLM), such as using CLIP (Contrastive Language-Image Pre-training) which accepts both an image and a natural language text as an input, and outputs a similarity score (i.e., the identification confidence score) indicating how well the image (i.e., the enlarged image) matches the text description (i.e., the target description). If the identification confidence score exceeds the identification confidence threshold (e.g., related to cosine similarity), the enlarged image is considered as matching to the target description, meaning that the candidate belongs to the target category that is indicated by the target description. These model names are non-limiting examples.

In some embodiments, the one or more target identification methods may include using a few-shot learning model, which may recognize the object category of the candidate from a small number (e.g., typically between 1 and 10) of example images. The user may provide the example images of the target object at the start of a search task. The few-shot learning model is valuable for identifying specific instances of objects that are not in standard training datasets. These model families are non-limiting examples.

The processing unit 2 may apply one or more of these identification methods to each candidate. If multiple methods are applied, the processing unit 2 combines the identification confidence scores obtained respectively from the multiple methods using a fusion technique such as weighted averaging, max-pooling, or a learned fusion function, so as to obtain a combined identification confidence score. The candidate with the highest combined identification confidence score is identified as the target object (hereinafter referred to as “target”). In this disclosure, the identification methods primarily establish whether the candidate should enter an uncertainty-bounded guidance loop. When the combined identification confidence score exceeds the identification confidence threshold (i.e., a match threshold), the candidate enters the uncertainty-bounded guidance loop, where the combined identification confidence score may be used to trigger generation of a spatial uncertainty region (sub-step S28), subsequent iterative refinement according to a geometrically structured reduction criterion during re-acquisition, and downstream sensor handoff confirmation including identity-consistency evaluation. Once a candidate object is determined to match the target description by the target identification method, the candidate object is referred to as the target object, and its representation extracted from any image captured by the camera module is referred to as the target representation. The same target representation continues to be used in subsequent sensor handoff confirmation and arrival determination steps.

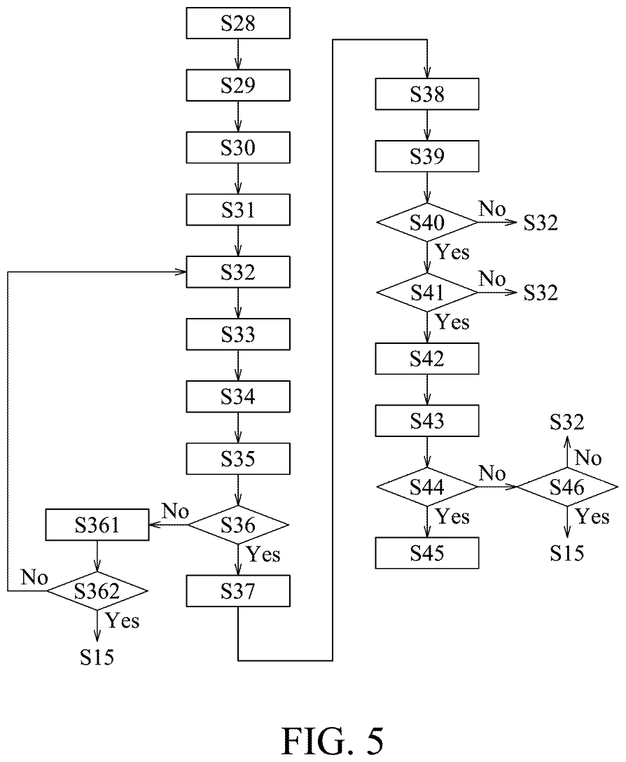

Referring further to FIG. 5, upon identifying the target in the enlarged image, the processing unit 2 performs a guidance and approach procedure (step S14), which includes sub-steps S28 to S45. The processing unit 2 determines a three-dimensional location of the target in the environment. Specifically, the processing unit 2 addresses this by projecting the bounding box that corresponds to the target detected in the enlarged image as an uncertainty cone in a SLAM coordinate system, where the uncertainty cone is the spatial uncertainty region representing an estimated location of the target in the environment.

The spatial uncertainty region disclosed herein is derived specifically from the projection of an image-space detection region (i.e., in the image coordinate system) into three-dimensional space (i.e., in the SLAM coordinate system) using geometric camera parameters, rather than from statistical estimation methods such as Kalman filtering or particle filtering applied to position estimates. This projection-based derivation preserves the geometric relationship between the image-plane observation and the physical space, enabling the spatial uncertainty region to be progressively refined through sequential geometric intersections as the autonomous mobile platform 100 moves to different viewpoints. The projection-based approach is fundamentally different from probabilistic position-tracking approaches that estimate a point position with an associated covariance, because the disclosed spatial uncertainty region represents a bounded physical volume with defined geometric boundaries rather than a probability distribution over possible positions.

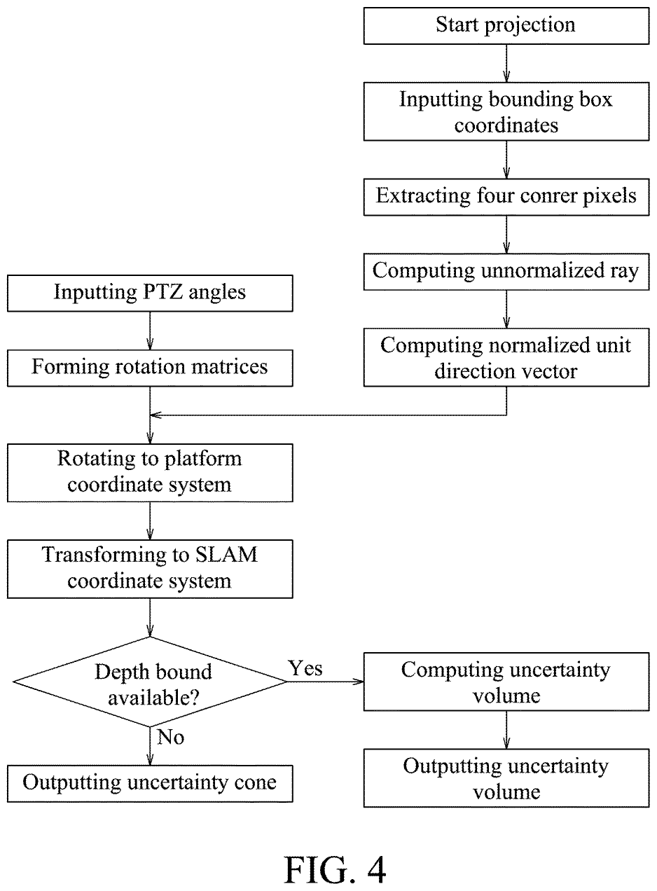

See FIG. 4 for details of obtaining the spatial uncertainty region through projection of the bounding box of the target from the image coordinate system to the SLAM coordinate system. The input to uncertainty cone projection is the bounding box coordinates (x_min, y_min, x_max, y_max, in the image coordinate system) of the target in the enlarged image. The intrinsic parameters for the PTZ camera include: the focal length components f_x and f_y, the principal point (c_x, c_y), and radial and tangential distortion coefficients. These parameters are stored in the camera intrinsic matrix K, a 3×3 matrix, where K=[[f_x, 0, c_x], [0, f_y, c_y], [0, 0, 1]].

The processing unit 2 computes a projection ray for each corner of the bounding box. For each corner pixel (u_i, v_i), an unnormalized ray direction in the camera frame (i.e., in the camera coordinate system) (r_cam_i) is first computed as: r_cam_i=K_inverse*[u_i, v_i, 1]_transposed. The normalized unit direction vector (d_cam_i) is then obtained as: d_cam_i=r_cam_i/∥r_cam_i∥. This yields a unit direction vector d_cam_i in the camera coordinate system, pointing from a camera center of projection through the pixel in an image plane.

The PTZ camera has the motorized pan and tilt actuator. The pan angle (theta_pan) and the tilt angle (theta_tilt) define rotation matrices R_pan and R_tilt. In one coordinate convention adopted for this disclosure, R_pan is a rotation about the vertical axis (Y) by theta_pan, where: R_pan=[[cos(theta_pan), 0, sin(theta_pan)], [0, 1, 0], [−sin(theta_pan), 0, cos(theta_pan)]]. R_tilt is a rotation about the horizontal axis (X) by theta_tilt, where: R_tilt=[[1, 0, 0], [0, cos(theta_tilt), −sin(theta_tilt)], [0, sin(theta_tilt), cos(theta_tilt)]]. Other coordinate conventions may be adopted depending on the autonomous mobile platform 100 and PTZ camera configuration. The ray direction (d_platform_i) in the platform frame (i.e., the platform coordinate system) is: d_platform_i=R_tilt*R_pan*d_cam_i.

The position and the orientation of the autonomous mobile platform 100 in the SLAM coordinate system is estimated by the SLAM algorithm as the autonomous mobile platform 100 moves. Let R_body denote the rotation component and t_body denote the translation component of a pose of the autonomous mobile platform 100 as estimated by the SLAM algorithm. The ray direction (d_world_i) in the SLAM coordinate system is: d_world_i=R_body*d_platform_i. The ray origin (o_world) in the SLAM coordinate system is: o_world=R_body*t_cam_to_body+t_body, where t_cam_to_body is the fixed translation from the camera center to a body center of the autonomous mobile platform 100. It should be noted that the SLAM algorithm receives inputs from the range imaging module 4 (e.g., LiDAR point clouds, RGB-D depth and color images, and/or IMU readings) and continuously estimates the pose of the autonomous mobile platform 100 by feature extraction, data association, pose graph optimization or extended Kalman filter updating, and loop closure detection. The estimated pose is provided as a rotation component R_body and a translation component t_body for use in coordinate transformations.

The four projection rays from the bounding box corners define the uncertainty cone in a three-dimensional (3D) space. The uncertainty cone is the angular domain enclosed by the four rays emanating from the camera center (o_world) in directions (d_world_1, d_world_2, d_world_3, d_world_4) in the SLAM coordinate system.

If depth data from the range imaging module 4 is available, the uncertainty cone is further bounded by a near depth limit and a far depth limit to form an uncertainty volume. The depth-bounded uncertainty volume is defined as the convex hull of the corner-ray points evaluated at the near depth bound (d_near) and the far depth bound (d_far). Specifically, eight points are computed, where: P_near_i=o_world+d_near*d_world_i and P_far_i=o_world+d_far*d_world_i for i in {1, 2, 3, 4}. The uncertainty volume is the convex hull of {P_near_1, P_near_2, P_near_3, P_near_4, P_far_1, P_far_2, P_far_3, P_far_4}, forming a frustum-like polyhedron. If depth measurements (i.e., direct range measurements from the range imaging module 4) are available along the projection ray directions from LiDAR or RGB-D sensors, the processing unit 2 uses those depth measurements as d_near and d_far. In some embodiments, the depth bounds (i.e., the near depth limit and the far depth limit) may alternatively be obtained from semantic-map constraints, known surfaces or planes in the environment, occupancy boundaries, or class-based geometric priors.

The angular half-width of the uncertainty cone can be approximated as alpha, which approximately equals arctan(Delta_u/n2*f_x)), where Delta_u=x_max-x_min, and is a width of the bounding box in pixels, and f_x is the focal length in pixels. At a distance D from the PTZ camera, a spatial width of the uncertainty region is approximately W(D), which approximately equals 2*D*tan(alpha). This demonstrates that as the autonomous mobile platform 100 moves closer to the target (D decreases), the spatial width W shrinks, providing progressively higher spatial resolution.

The centroid of the spatial uncertainty region (e.g., the uncertainty volume) serves as a candidate navigation waypoint. The centroid is computed as “c”, which approximately equals (⅛)*sum of {P_near_i+P_far_i} for i=1 to 4. In sub-step S29, a navigation waypoint may be obtained as a traversable point selected from: (i) the centroid of the uncertainty volume, (ii) a nearest traversable point within or relative to the spatial uncertainty region as determined by the semantic 3D map, (iii) a point that preserves line-of-sight visibility to the target from the autonomous mobile platform 100, or (iv) a task-specific approach pose determined by the action command. The waypoint selection accounts for traversability constraints, obstacle avoidance requirements, and the need to maintain visual contact with the target during approach. It should be noted that the nearest traversable point is the traversable cell in the semantic 3D map (e.g., free-space cell or ground-plane cell) closest to the spatial uncertainty region. It is selected when the centroid of the uncertainty volume falls within an obstacle or prohibited region.

When the autonomous mobile platform 100 moves and re-acquires the target, a new uncertainty region (U_new) may be computed from the re-acquisition. Each uncertainty region may be associated with a confidence measure derived from the detection confidence score; the confidence measure is updated after each re-acquisition. As used herein, a reduction criterion refers to a geometrically structured rule for refining the spatial uncertainty region toward a smaller or otherwise more bounded estimate of a target location (i.e., a location of the target) using successive observations of the target object taken from distinct observation viewpoints when available. That is, the reduction criterion may be used for reducing a spatial extent of the spatial uncertainty region by constraining at least one of a plurality of boundaries of the spatial uncertainty region (e.g., constraining one or more region boundaries, angular bounds, or depth bounds of the spatial uncertainty region). The reduction criterion includes, for example, geometric intersection of uncertainty regions derived from distinct observation viewpoints, angular-bound narrowing derived from successive observations, and depth-bound tightening derived from successive observations, but the disclosure is not limited to such. The refined uncertainty region (U_refined) is the intersection: U_refined=U_previous intersection U_new. This sequential intersection rule progressively shrinks the uncertainty region as more observations are accumulated from different viewpoints, converging toward the true target location. If the intersection is empty or falls below a minimum overlap criterion (e.g., the intersected volume is less than a configurable percentage of a smaller one of U_previous and U_new), the processing unit 2 applies one of the following fallback strategies: (a) computing a confidence-weighted union of U_previous and U_new, giving greater weight to the region associated with a higher detection confidence score; (b) relaxing one or more depth bounds or angular thresholds and re-attempting the intersection; (c) retaining whichever of U_previous and U_new that is associated with the higher detection confidence score; or (d) reverting to a re-search procedure (i.e., entering a RE-SEARCH state), which includes re-acquisition of the new uncertainty region (U_new) as mentioned above, and will be described later.

The processing unit 2 may also incorporate additional points along the bounding box edges (not just corners) and compute rays for these points. Sampling N points along the bounding box boundary and computing N rays provides a finer approximation of the cone shape. In some embodiments, the processing unit 2 may use a segmentation mask rather than a bounding box, sampling points along the segmentation boundary to define the uncertainty cone more precisely.

Once the processing unit 2 has localized the target within an uncertainty region in a SLAM map, the next step is to determine a navigation path (sub-step S30). The processing unit 2 selects a waypoint derived from the uncertainty region as described above in sub-step S29. In some embodiments, the processing unit 2 may determine the navigation path (from a current location of the autonomous mobile platform to the navigation waypoint) to be collision-free using any path planning algorithm such as A*(A-star), RRT (Rapidly-Exploring Random Trees), or Dijkstra's algorithm on the semantic 3D map. It should be noted that if the navigation path is unavailable (i.e., no feasible path has been obtained), the processing unit 2 may report task failure to, for example, the upstream controller.

It should be noted that the SLAM map (i.e., a semantic 3D map) is generated by the processing unit 2 running the SLAM algorithm, and includes information about traversable regions and obstacles. The processing unit 2 runs the path planning algorithm to use the SLAM map to compute the navigation path that avoids obstacles. The navigation path being computed is typically a sequence of waypoints, each specifying a target pose of the autonomous mobile platform 100 to approach in the SLAM coordinate system.

The path planning may incorporate a line-of-sight constraint, ensuring the target remains visible to the PTZ camera during movement, avoiding occlusions along the navigation path. The processing unit 2 may select or update intermediate waypoints to maintain line-of-sight visibility of the target based on an analysis of any occluding obstacles in the semantic 3D map.

In some embodiments, the processing unit 2 selects PTZ camera control actions (which may be pre-stored in the memory module 7) based on a measure of spatial uncertainty associated with the current uncertainty region. Specifically, the processing unit 2 may adjust the pan angle, the tilt angle, or the focal length of the camera module 3 to reduce an angular extent or a spatial volume of the uncertainty region. For example, increasing the focal length (zooming in) narrows the angular subtense of the bounding box, directly reducing the angular half-width of the uncertainty cone. Alternatively, the processing unit 2 may select an observation direction of the camera module 3 that maximizes the expected reduction in uncertainty volume upon the next re-acquisition, such as by choosing an observation angle that is substantially different from previous observation angles to improve triangulation geometry. The selection of PTZ camera control actions to reduce uncertainty distinguishes the disclosed system from systems that merely point the PTZ camera toward an estimated target direction without considering the effect on spatial uncertainty.

In sub-step S31, with the navigation path computed, the processing unit 2 controls the actuating module 5 to move the autonomous mobile platform 100 along the navigation path in incremental steps. At each incremental step, the processing unit 2 issues a command to the actuating module 5 specifying a desired motion for moving the autonomous mobile platform 100.

As the autonomous mobile platform 100 moves along the navigation path, the processing unit 2 continuously executes iterative re-acquisition of the target, which includes sub-steps S32 to S38. At each position along the navigation path, the processing unit 2 performs the following: (1) perform sub-step S32 to compute an expected target direction based on the last known target location, where the expected target direction points from the autonomous mobile platform 100 toward the last known target location; (2) perform sub-step S33 to command the PTZ camera to point toward the expected target direction and, in some embodiments, selectively adjust the focal length or the observation direction of the camera module to improve observation quality for uncertainty reduction; (3) perform sub-step S34 to capture another enlarged image of the target; (4) perform sub-step S35 to apply the object detection model to detect the target in the enlarged image last captured in sub-step S34; (5) if the target is successfully detected, perform sub-step S37 to obtain a new bounding box; (6) perform sub-step S38 to recomputed the uncertainty cone and intersect with the previous uncertainty region, and apply any one of the fallback strategies of paragraph [0067] if necessary; and (7) perform sub-step S39 to adjust the navigation path if needed, including updating the waypoint per the waypoint selection criteria as mentioned previously. It should be noted that after performing sub-step S35, the processing unit 2 performs sub-step S36 to determine whether the target is successfully detected in the enlarged image last captured in sub-step S34. If the target is successfully detected, the flow proceeds to sub-step S37; otherwise, the flow proceeds to sub-step S361, where the processing unit 2 increments a consecutive loss counter to count a number of times of not detecting the target in the iterative re-acquisition step. After sub-step S361, the flow proceeds to sub-step S362, where the processing unit 2 determines whether the consecutive loss counter has exceeded a loss threshold. If the consecutive loss counter has exceeded the loss threshold, the flow proceeds to step S15; otherwise, the flow returns to sub-step S32.

The iterative re-acquisition (sub-steps S32 to S39) provides two benefits. First, it improves the localization accuracy. Second, it provides feedback to detect whether the target has moved or been lost.

The iterative re-acquisition is not merely a passive detection loop but constitutes an active perception strategy in which the processing unit 2 exploits the geometric diversity of sequential observations to achieve progressive uncertainty reduction. As the autonomous mobile platform 100 moves along the navigation path, each new observation is taken from a different spatial position and potentially a different PTZ configuration, providing a different angular perspective on the target. The intersection of uncertainty volumes derived from geometrically diverse viewpoints converges more rapidly than observations from similar viewpoints, and the processing unit 2 may preferentially select navigation paths or intermediate waypoints that increase the angular baseline between successive observations. Accordingly, the disclosed system selects sensing actions to reduce uncertainty, not merely to observe the target. It should be noted that the angular baseline refers to the angle subtended at the target object by two camera positions in successive observations. A larger angular baseline yields faster convergence of the uncertainty region.

The iterative re-acquisition uses the same target identification methods employed in the hierarchical search procedure. Only if the identification confidence score is sufficiently high does the processing unit 2 accept the detection as a valid re-acquisition.

As the autonomous mobile platform 100 approaches the target, the processing unit 2 transitions from relying on the PTZ camera for long-range imaging to relying on the secondary sensor 9 for close-range detection and action execution. This transition is termed sensor handoff.

Sensor handoff confirmation is initiated when a proximity condition associated with the spatial uncertainty region is satisfied. In sub-step S40, the processing unit 2 determines whether the proximity condition is satisfied, when the proximity condition is satisfied, the flow proceeds to sub-step S41; otherwise, the flow returns to sub-step S32. In some embodiments, the proximity condition is satisfied when an estimated distance to the target (d_target) derived from the spatial uncertainty region falls below a handoff range threshold (d_handoff) (e.g., 3 to 10 meters, configurable based on an effective range of the secondary sensor 9). In some embodiments, the proximity condition is additionally or alternatively satisfied when a spatial volume, a longest dimension, or an uncertainty-bound diameter of the spatial uncertainty region falls below a proximity threshold, or when the spatial uncertainty region intersects an effective sensing zone of the at least one secondary sensor 9. Once the proximity condition is satisfied, the processing unit 2 begins periodically attempting to detect the target using the secondary sensor 9.

In some embodiments, the secondary sensor 9 may include: (1) an RGB-D sensor that provides both a color image and a depth map, (2) a LiDAR that provides a 3D point cloud, (3) a thermal infrared camera that images in the infrared spectrum, or (4) ultrasonic sensors that measure distance by timing ultrasonic pulses.

The processing unit 2 transfers data from the PTZ-based detection function to the secondary-sensor confirmation function during sensor handoff. Data passed from the PTZ-based detection function to the secondary-sensor confirmation function within the processing unit 2 during sensor handoff includes: the target category, the identification confidence score from the PTZ-based target identification, the projected 3D location of the target from the uncertainty cone, the bounding box of the target in the enlarged image, an approach direction vector, an appearance embedding or template descriptor extracted from the PTZ image, and semantic attributes of the target (e.g., color, shape, estimated size). The appearance embedding or template descriptor facilitates identity-consistency verification during sensor handoff confirmation and maintains identity continuity between long-range detection by the camera module and close-range verification by the at least one secondary sensor.. It should be noted that the appearance embedding is a feature vector extracted from a target crop using a deep neural network backbone (e.g., ResNet, EfficientNet, or Vision Transformer). Two crops of the same target object yield embeddings having a high cosine similarity, while crops of different objects yield low similarity. A template descriptor refers, alternatively, to a hand-crafted feature representation such as HOG, SIFT keypoint descriptors, or a normalized image patch used as a matching template. It should be further noted that close-range confirmation includes one or more of: (a) close-range detection of the target object, (b) identity verification by comparing secondary-sensor representation with the appearance embedding or template descriptor, (c) OCR or barcode decoding, point cloud density measurement, depth measurement, or thermal measurement, and (d) task-specific verification defined by the action command.

Sensor handoff is confirmed when the target's representation in the secondary sensor 9 meets one or more threshold conditions selected from: (a) the target's representation captured (e.g., as a secondary sensor image) by the secondary sensor 9 exceeds a target-occupancy threshold T_occ, indicating the target spans at least a minimum number of pixels in the secondary sensor image (e.g., at least 50 pixels in width); (b) the target's representation captured (e.g., as secondary sensor data) by the secondary sensor 9 exceeds a detection-confidence threshold T_conf, indicating a secondary detection model applied to the secondary sensor data outputs an identification confidence score (indicating a confidence of whether the target belong to the target category) exceeding the detection-confidence threshold; (c) the target's representation captured (e.g., as the secondary sensor image) by the secondary sensor 9 exceeds an OCR-readability threshold, indicating a text on the target is resolvable with a character confidence exceeding a minimum OCR character confidence threshold; (d) the target's representation captured (e.g., as the secondary sensor image) by the secondary sensor 9 exceeds a barcode-decodability threshold, indicating a barcode or a QR code on the target is visible and decodable with a decode confidence exceeding a minimum barcode decode confidence threshold; (e) the target's representation captured by the secondary sensor 9 exceeds a point-cloud-density threshold T_density, indicating the point cloud from LiDAR contains at least a minimum number of points per square meter on the target surface; (f) the target's representation captured by the secondary sensor 9 exceeds a target-distance-consistency threshold, indicating the distance to the target measured by the secondary sensor 9 is consistent with the projected distance from the PTZ-based estimate (within a tolerance epsilon_d), where the projected distance from the PTZ-based estimate is the estimated target distance to the target (d_target) derived from the spatial uncertainty region; (g) the target's representation captured by the secondary sensor 9 exceeds an identity-consistency threshold, that is to say, a similarity metric between the PTZ-based target representation (such as the appearance embedding or template descriptor) and the secondary-sensor target representation (such as the secondary sensor image or the secondary sensor data) exceeds the identity-consistency threshold, wherein the similarity metric may be evaluated using cosine similarity, feature-space distance, template match score, or another correspondence metric; or (h) the target's representation captured by the secondary sensor 9 exceeds a task-specific quality threshold defined by the action command, examples of which include a minimum thermal contrast for infrared tasks, a minimum focus or blur metric for imaging tasks, or a minimum point density for 3D scanning tasks.

The processing unit 2 maintains a sensor handoff confirmation status for each sensor type of the at least one secondary sensor 9. Once a sensor among the at least one secondary sensor 9 successfully detects the target and meets the threshold conditions as mentioned above, that sensor transitions to a confirmed state. The system does not require all sensors to be confirmed; rather, it requires that at least one sensor critical for the intended action is confirmed.

In some embodiments, the processing unit 2 determines whether the sensor handoff confirmation has failed for a maximum number of consecutive handoff attempts (N_handoff) (e.g., 3 to 5 attempts), if the sensor handoff confirmation has failed for the maximum number of consecutive handoff attempts, the processing unit 2 transitions to the RE-SEARCH state (step S15); otherwise, if the sensor handoff confirmation has not yet failed for the maximum number of consecutive handoff attempts, the flow returns to sub-step S32. The RE-SEARCH state includes performing any of the following actions: widening the field of view of the PTZ camera and perform re-acquisition to attempt a wider re-acquisition, commanding the autonomous mobile platform 100 to approach the target from a different angle, or commanding the autonomous mobile platform 100 to backtrack to a position where the target was last confirmed visible as viewed from the autonomous mobile platform 100.

The processing unit 2 determines arrival of the autonomous mobile platform 100 to the target through a two-stage protocol, including an approaching stage and a verifying stage. In the first stage (an APPROACHING state), the processing unit 2 performs sub-step S41 to evaluate pre-arrival trigger conditions (i.e., to determine whether any pre-arrival trigger condition is met). The pre-arrival trigger conditions include: the bounding box of the target occupying at least a threshold percentage of the enlarged image frame, the estimated distance to the target falling below a proximity threshold, or any of the secondary sensor 9 beginning to register the target. When it is determined that at least one pre-arrival trigger condition is met, the processing unit 2 transitions to the VERIFYING state (sub-step S42). In the second stage (the VERIFYING state), the processing unit 2 performs sub-step S43 to perform sensor handoff confirmation. The processing unit 2 performs sub-step S44 to determine whether sensor handoff confirmation is successful, and proceeds to sub-step S45 when the sensor handoff confirmation is successful. When it is determined that the sensor handoff confirmation is not successful, the flow proceeds to sub-step S46, where the processing unit 2 further determines whether the sensor handoff confirmation has failed for the maximum number of consecutive handoff attempts (N_handoff) as described in paragraph [0084]. An ARRIVED state is entered (sub-step S45) only when sensor handoff confirmation is successful and one or more arrival confirmation conditions are satisfied. The arrival confirmation conditions are selected from: (i) a target-occupancy condition requiring the bounding box of the target to occupy at least a threshold percentage of the image frame, (ii) a sensor-confirmation condition requiring the at least one secondary sensor 9 to have detected the target and to have met a corresponding threshold condition for the downstream task, (iii) a distance condition requiring the estimated distance from the autonomous mobile platform 100 to the target is less than a distance threshold, or (iv) a combined condition requiring at least two of conditions (i) through (iii) to be simultaneously satisfied. It should be noted that the corresponding threshold condition for the downstream task is selected based on the action command of the search task. For example: an OCR task requires a minimum character confidence; a barcode task requires a minimum decode confidence; a thermal task requires a minimum thermal contrast; a manipulation task requires a minimum point cloud density and a maximum surface normal deviation; a high-resolution imaging task requires a minimum focus quality metric.

For condition (i), the threshold percentage can be adjusted based on the expected target size and required interaction distance. Smaller threshold percentages (e.g., 30%) indicate larger acceptable approach distances, while larger percentages (e.g., 90%) enforce closer approach.

When the processing unit 2 determines that the arrival confirmation conditions have been met and sensor handoff confirmation is successful, the processing unit 2 transitions the autonomous mobile platform 100 to an EXECUTING state (sub-step S45). In the EXECUTING state (i.e., in sub-step S45), the processing unit 2 performs the action command specified in the search task: acquiring a high-resolution photograph, reading text with OCR, scanning a barcode or QR code, taking thermal measurements, recording video, or performing a manipulation action. It should be noted that step S15 may be omitted if the arrival confirmation condition is met and the autonomous mobile platform 100 is able to perform the action command to the target.

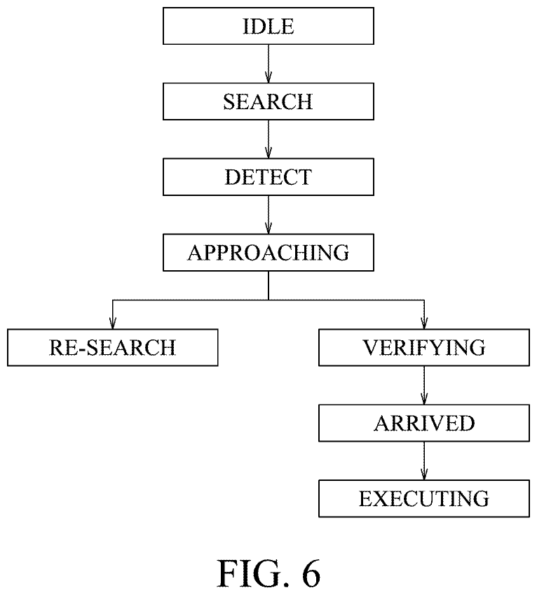

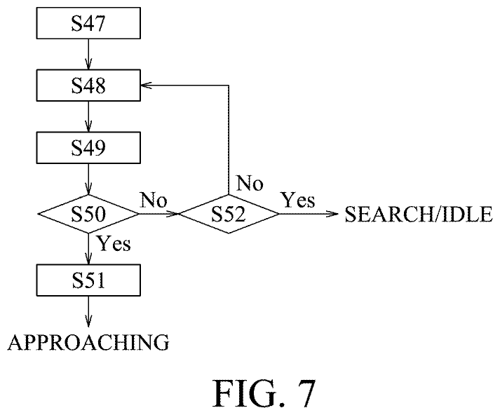

The processing unit 2 manages the execution of the target search and autonomous guidance method using a state machine with multiple states. Referring to FIG. 6, the state machine includes the following states.

An IDLE state: The autonomous mobile platform 100 is idle, awaiting a search task. The processing unit 2 continuously monitors trigger sources. When a search task is received, the processing unit 2 transitions to a SEARCH state.

The SEARCH state: The processing unit 2 executes the hierarchical search procedure. When a target is successfully identified with sufficiently high identification confidence score, the processing unit 2 computes the uncertainty cone and transitions to a DETECTED state. If the search fails to find any matching candidate, the processing unit 2 may transition back to the IDLE state after a timeout.

The DETECTED state: The processing unit 2 computes a navigation path and prepares to move. Once the path is computed and verified feasible, the processing unit 2 transitions to the APPROACHING state.

The APPROACHING state: The processing unit 2 controls the autonomous mobile platform 100 to move along the navigation path with iterative re-acquisition. If one or more pre-arrival trigger conditions are met, the processing unit 2 transitions to the VERIFYING state. If the target is lost (not re-detected for a maximum number of consecutive attempts, or the loss threshold) as described in sub-step S362, the processing unit 2 transitions to the RE-SEARCH state.

The RE-SEARCH state: The processing unit 2 moves the autonomous mobile platform 100 to a new vantage point and re-attempts to locate the target using a last known position of the target object as a reference. The new vantage point may be selected based on obstacle bypass requirements, line-of-sight recovery to a last known target direction, or an uncertainty-region visibility score quantifying what proportion of the last known uncertainty region is visible from the candidate vantage point. Specifically, the processing unit 2 perform a targeted search in a vicinity of the last known position of the target object using a last computed spatial uncertainty region to narrow a search area. If the target is re-acquired, the processing unit 2 transitions to the APPROACHING state. If the object is not re-located after a maximum number of re-search attempts, the processing unit 2 transitions to the SEARCH state for a broader search or reports task failure and returns to the IDLE state.

The VERIFYING state: The processing unit 2 performs sensor handoff confirmation. Once handoff is confirmed for at least one critical sensor and one or more arrival confirmation conditions are satisfied, the processing unit 2 transitions to the ARRIVED state. If handoff cannot be confirmed, the processing unit 2 transitions back to the APPROACHING state for a different approach angle or reports task failure.

The ARRIVED state: Arrival confirmation conditions are satisfied and sensor handoff confirmation is successful. In the ARRIVED state, the processing unit 2 latches the current platform pose, logs the arrival event to the memory module 7, performs a final safety check, and loads action-specific parameters corresponding to the action command. The processing unit 2 then transitions to an EXECUTING state.

The EXECUTING state: The processing unit 2 executes the action command. Upon successful execution of the action command, the processing unit 2 reports task completion and transitions to the IDLE state.

During the APPROACHING state, if the re-acquisition of the target in the PTZ image is not successful for a maximum number of consecutive re-acquisition attempts (e.g., three, five, or ten consecutive failures), the processing unit 2 determines that the target has been lost. This may occur if the target has moved, if an obstacle has obscured the target, or if the previous detection was a false positive.

Upon detecting target loss, the processing unit 2 transitions to the RE-SEARCH state (step S15), and performs the re-search procedure, which includes sub-steps S47 to S52. In sub-step S47, the processing unit 2 records a last known position of the target in the SLAM map. In sub-step S48, the processing unit 2 computes a new vantage point by: (1) offsetting the current position laterally, (2) moving to a different elevation for the UAVs, (3) moving around a potentially occluding obstacle, or (4) backtracking along the navigation path.

In sub-step S49, from the new vantage point, the processing unit 2 performs a targeted search in the direction of the last known target position. The search uses the last computed uncertainty region to narrow the search area. In sub-step S50, the processing unit 2 determines whether the target is re-acquired from the new vantage point, if the target is re-acquired, the flow proceeds to sub-step S51, where the processing unit 2 updates the uncertainty cone, and transitions back to the APPROACHING state (sub-step S41).

If the target cannot be re-located (i.e., the target is not re-acquired in sub-step S50), the flow proceeds to step S52, where the processing unit 2, determines whether a number of time of attempting to re-acquire the target has exceed a maximum number of re-search attempts. If the number of time of attempting to re-acquire the target has exceed the maximum number of re-search attempts, the processing unit 2 may transition to the SEARCH state for a full panoramic search or may report task failure and return to the IDLE state. The behavior is configurable based on the search task parameters. If the number of time of attempting to re-acquire the target has not exceed the maximum number of re-search attempts, the flow returns to sub-step S48.

The method and system can be implemented on a variety of autonomous mobile platforms. A primary embodiment is an unmanned ground vehicle (UGV) or autonomous mobile robot (AMR) operating in structured or semi-structured environments such as warehouses, factories, or campuses. A wheeled mobile robot comprises wheels actuated by electric motors. A tracked mobile robot uses continuous tracks. A humanoid robot comprises a bipedal body. An unmanned aerial vehicle (UAV) can navigate in three dimensions. An unmanned surface vessel (USV) is a waterborne platform. Each autonomous mobile platform type adapts the actuating module 5 and path planning to its locomotion modality.

In another embodiment, the autonomous mobile platform 100 incorporates multiple camera modules, including the PTZ camera and one or more additional fixed-FOV cameras for wide-angle observation and obstacle avoidance.

In another embodiment, the camera module 3 comprises a multi-lens turret with multiple fixed lenses of different focal lengths rather than a continuously variable zoom lens.

In another embodiment, the processing unit 2 is distributed across multiple computing nodes. The object detection model may execute locally on an edge GPU while computationally intensive tasks such as VLM or few-shot learning may be offloaded to a cloud server.

In another embodiment, the autonomous mobile platform 100 includes thermal infrared imaging capability for identifying warm or cold targets in visually complex scenes.

In another embodiment, multiple autonomous mobile platforms 100 may cooperate to search for the same target. A central server or fleet management system coordinates the autonomous mobile platforms 100, dispatching search tasks and sharing target information.

The method and system are applicable to surveillance and monitoring, search and rescue, warehouse inventory, agricultural inspection, infrastructure monitoring, and industrial inspection.

The following additional exemplary embodiments are provided to further illustrate non-limiting implementations of the disclosed target search, uncertainty-bounded guidance, sensor handoff, arrival confirmation, and downstream action execution architecture. Unless expressly stated otherwise, the numerical values, thresholds, target types, sensor selections, map constraints, and task parameters described below are exemplary and may be varied according a size of the autonomous mobile platform 100, environment, mission objectives, sensor capability, and regulatory or safety requirements.

In one exemplary warehouse implementation, the search task specifies a carton, tote, pallet, or storage bin identified by a textual description, a stock keeping unit, a lot code, a barcode value, or a reference image. The processing unit 2 performs a panoramic sweep along warehouse aisles, identifies candidate containers using the object detection model, and then zooms in on a selected candidate for fine identification. In one non-limiting example, the fine identification stage combines a classification model, OCR of printed alphanumeric markings, and barcode or QR decoding. The generated spatial uncertainty region may be bounded not only by direct depth measurements but also by a known shelf plane, rack face, pallet bay geometry, or floor reference in the semantic map. A navigation waypoint may then be selected as a traversable pose in the aisle that preserves line-of-sight to the candidate while keeping the autonomous mobile platform 100 outside a no-entry zone around racking or forklift traffic lanes. Handoff may be initiated when the estimated target distance falls below an exemplary range of about 2 meters to about 5 meters, and handoff confirmation may require both successful barcode decoding and depth consistency between the PTZ-derived estimate and an RGB-D measurement before the ARRIVED state is entered.

In one exemplary industrial inspection implementation, the target is a dial gauge, digital meter, label plate, switch position indicator, or valve assembly mounted on a machine, panel, pipe rack, or wall. The target description may include a target class, an equipment identifier, a color cue, an expected installation zone, or a text string to be read after arrival. During approach, the processing unit 2 may update the navigation waypoint to route around pipes, barriers, and safety rails while preserving visibility of the target. In one non-limiting example, arrival is not declared merely because the target occupies a large portion of the PTZ image; instead, the system transitions to the VERIFYING state and requires one or more close-range conditions, such as an OCR readability threshold for a meter display, a focus-quality threshold for a nameplate, or a distance condition confirming that the autonomous mobile platform 100 is within a permitted reading distance, before executing a reading or image-capture action.

In one exemplary thermal inspection implementation, the target corresponds to an asset associated with an abnormal temperature pattern, such as an electrical cabinet, transformer component, bearing housing, motor casing, or pipe segment. A PTZ image may be used for long-range candidate acquisition and semantic localization, while a thermal infrared secondary sensor is used for close-range confirmation. In one non-limiting example, the task-specific quality threshold of the handoff stage includes a minimum thermal contrast relative to a background, a minimum number of thermally significant pixels, or a requirement that the hottest region fall within a mapped asset boundary associated with the target. Thus, the PTZ camera may identify the correct asset and the thermal sensor may confirm the task-relevant condition before a downstream reporting, imaging, or maintenance workflow is initiated.

In one exemplary search-and-rescue implementation, the target description may identify a person, article of clothing, backpack, emergency beacon, stretcher marker, or other mission object of interest in a cluttered or partially occluded environment. A user or upstream controller may provide one or more reference images, such as from about one image to about ten images, to initialize few-shot identification. During iterative re-acquisition, the processing unit 2 may give greater weight to more recent uncertainty regions when evidence suggests that the target is moving, while still using geometric constraints from earlier observations when such observations remain consistent. If the target disappears behind rubble, vegetation, smoke, or a structural obstacle, the autonomous mobile platform 100 may transition to the RE-SEARCH state, move to a laterally offset vantage point or a higher observation elevation, and then resume targeted search using the last known uncertainty region as a prior.

In one exemplary distractor-rejection implementation, the environment contains multiple visually similar candidates, such as many identical totes, many white service vehicles, or multiple valves of the same form factor. The processing unit 2 therefore applies at least two identification modalities to the enlarged PTZ image, for example a CNN or Vision Transformer classifier together with reference image matching, a vision-language similarity score, OCR, or barcode decoding. A candidate having a high score in only one modality but inconsistent evidence in another modality may be rejected even if its bounding box is visually prominent. In this manner, the autonomous mobile platform 100 may avoid approaching the nearest detected object when target-specific identity evidence indicates that the candidate does not sufficiently correspond to the search task.

In one exemplary map-constrained localization implementation, direct range data for the target is sparse, intermittent, or unavailable at the moment of long-range PTZ detection. The processing unit 2 may nevertheless bound the uncertainty cone using semantic-map constraints, such as a known wall plane, a cabinet front plane, a shelf surface, a corridor boundary, a ground plane, or a machine envelope already represented in the semantic three-dimensional map. For example, when the target is known to be attached to a wall panel, the projected observation rays may be intersected with that wall plane to tighten the far depth bound and eliminate physically implausible target locations floating in free space. In another example, when a target is expected to rest on a rack shelf or on the ground, the near and far bounds may be constrained by the corresponding mapped support surface and obstacle boundaries.

In one exemplary contour-based implementation, the candidate representation used for uncertainty generation is a segmentation mask, contour, polygonal outline, or another non-rectangular region representation rather than a simple rectangular bounding box. This may be advantageous when the target is elongated, partially visible, or irregularly shaped, such as a pipe, lever, ladder, tool, cable run, rescue marker, or machine handle. The processing unit 2 may sample a plurality of contour points distributed along the visible boundary of the target and project those points into three-dimensional space to generate a tighter spatial uncertainty region than would be obtained from the outer limits of a coarse rectangular box. The processing unit 2 may also weight contour points according to edge confidence, segmentation confidence, or image sharpness when generating the updated uncertainty region.

In one exemplary multi-platform implementation, a fleet management system assigns an initial search task to a first autonomous mobile platform and later assigns a second autonomous mobile platform to perform close-range confirmation or task execution. The first autonomous mobile platform may transmit one or more of: the target category, a PTZ image crop, an appearance embedding, a last refined spatial uncertainty region, an expected approach direction, or a suggested waypoint. The second autonomous mobile platform may use the transmitted information thus received from the first autonomous mobile platform as an initialization prior, thereby reducing search time and improving cross-platform continuity. In some embodiments, the second autonomous mobile platform may also report new observations back to the first autonomous mobile platform or to the upstream controller so that the shared target estimate is updated cooperatively.

In one exemplary periodic monitoring implementation, the autonomous mobile platform 100 is scheduled to inspect the same set of assets repeatedly, such as a series of gauges, panels, storage bins, or infrastructure points distributed across a facility or campus. For each scheduled task, the target description may include one or more of a prior map location, a historical PTZ image, an allowed approach side to the target, a required sensor for confirmation, and a task-specific action command. The processing unit 2 may use the previously stored information to bias the coarse search toward expected target sectors while still preserving the ability to execute the full hierarchical search and re-search procedures if the asset has been moved, replaced, blocked, or visually altered. The same framework may therefore support both repeatable patrol scenarios and open-ended search scenarios.

In one exemplary occlusion-recovery implementation, the target is initially acquired, but a column, rack upright, parked vehicle, doorway edge, vegetation, or moving worker later blocks direct line-of-sight from the autonomous mobile platform 100 to the target. The processing unit 2 records the last valid uncertainty region, computes one or more candidate vantage points, and selects a new vantage point using at least one criterion such as visibility score, path cost, obstacle clearance, or expected angular baseline improvement. In one non-limiting example, the selected vantage point (i.e., the new vantage point thus selected) is not simply the closest free-space location; instead, the selected vantage point is a location predicted to expose a larger visible fraction of the uncertainty region while remaining traversable and safe. After moving the autonomous mobile platform 100 to the new vantage point, the system reorients the PTZ camera toward the last known target direction and resumes targeted detection and refinement.

In one exemplary arrival-verification implementation, the target may appear large in the PTZ image because the autonomous mobile platform 100 is close to an incorrect but similar object. For instance, two adjacent packages may share the same general size and color, or two side-by-side control panels may have similar layouts. The disclosed two-stage protocol for determining arrival of the autonomous mobile platform 100 to the target prevents premature declaration of arrival by requiring successful sensor handoff confirmation and at least one arrival confirmation condition after the autonomous mobile platform 100 has entered the VERIFYING state. Thus, even if a target-occupancy threshold is satisfied in the PTZ image, the system may remain in the VERIFYING state or return to the APPROACHING state if a barcode cannot be decoded, an OCR string does not match, a depth measurement is inconsistent, or the identity-consistency score falls below the identity-consistency threshold.

In one exemplary shared-sensor implementation, the range imaging module 4 and the secondary sensor 9 are implemented by a common RGB-D subsystem or a common LiDAR-centered sensing assembly operating in different modes (e.g., a first mode and a second mode), sampling densities, fields of view, or processing pipelines. The first mode may provide broader environmental depth cues useful for waypoint derivation and obstacle-aware motion, whereas the second mode may provide denser or more localized data for close-range confirmation, OCR support, surface reconstruction, or target-distance consistency checks. In another implementation, the shared sensor subsystem may switch between a wide field-of-view mode and a narrow field-of-view mode as the autonomous mobile platform 100 transitions from coarse guidance to close-range confirmation.

In one exemplary distributed-computing implementation, the object detection model and basic re-acquisition loop execute locally on an edge processor to preserve responsive PTZ control, while a more computationally intensive VLM, few-shot adaptation routine, or cross-sensor embedding comparison may be executed on a remote server (not shown) when communication quality permits. If network delay exceeds a delay threshold or connectivity to the remote server degrades, the processing unit 2 may temporarily continue navigation using locally available models and previously computed uncertainty regions, and may later incorporate cloud-returned identification evidence when available. The local and remote components may therefore operate cooperatively without interrupting the closed-loop target search and approach behavior.

In one exemplary aerial-platform implementation, the autonomous mobile platform 100 is a UAV and the selected vantage-point adjustment includes a controlled altitude change in addition to horizontal displacement. When the target is on or near the ground, roof, facade, or another extended surface, the processing unit 2 may refine the uncertainty region by intersecting projected observation rays with a semantic ground plane or building surface while selecting a subsequent observation viewpoint that increases angular baseline diversity. The UAV may thus reduce the uncertainty volume not only by zooming the PTZ camera but also by changing elevation to obtain a more informative perspective for re-acquisition and final confirmation.

In one exemplary action-execution implementation, the downstream task performed after the ARRIVED state is not limited to passive imaging. By way of non-limiting example, after successful handoff confirmation, the autonomous mobile platform 100 may actuate a manipulator to press a button, turn a valve, pull a handle, place a marker, collect a sample, position a scanner, or deliver an object to a location associated with the confirmed target. Before such an action is executed, the processing unit 2 may require an additional task-specific safety check, such as verifying manipulator reachability, confirming that the target surface is normal or an approach angle to the target falls within an allowable range, or confirming that the target identity remains consistent during the final pre-actuation interval.

In one exemplary threshold-management implementation, one or more of the match threshold, target-occupancy threshold, distance threshold, handoff range threshold, OCR-readability threshold, barcode-decodability threshold, point-cloud-density threshold, and identity-consistency threshold are not fixed at a single immutable value for all missions. Rather, the processing unit 2 may select or adapt the abovementioned thresholds according to one or more contextual factors including target category, expected target size, expected interaction distance, ambient illumination, motion state of the autonomous mobile platform 100, the type of the autonomous mobile platform 100, sensor noise level, weather or dust conditions, and the downstream action to be executed after arrival of the autonomous mobile platform 100 to the target. For example, a threshold selected for reading a small serial-number label may be stricter than a threshold selected for simply navigating to a large pallet or vehicle. Such threshold adaptation remains within the same disclosed closed-loop architecture because the adapted thresholds still govern candidate admission, uncertainty reduction, handoff confirmation, and arrival determination.

In one exemplary calibration-and-registration implementation, the processing unit 2 stores and periodically verifies intrinsic calibration parameters of the PTZ camera, kinematic offsets between the PTZ camera and a body frame of the autonomous mobile platform 100, and extrinsic relationships between the PTZ camera, the range imaging module 4, and the at least one secondary sensor 9. In one non-limiting example, the autonomous mobile platform 100 observes one or more fiducials, calibration boards, mapped landmarks, or known structural features in order to verify that pan angle, tilt angle, focal-length-dependent intrinsic parameters, and sensor-to-sensor transforms remain within acceptable tolerances. If a calibration inconsistency exceeding a threshold is detected, the processing unit 2 may widen the spatial uncertainty region, lower confidence associated with one or more observations, request re-calibration, or restrict task execution requiring higher positional precision. This embodiment provides an additional implementation pathway for maintaining geometric consistency between long-range PTZ observations and close-range confirmation.

In one exemplary degraded-sensing implementation, one or more sensing modalities may temporarily underperform because of blur, glare, rain, fog, smoke, dust, low illumination, reflective surfaces, partial lens obstruction, temporary communication loss, or sparse depth returns. The processing unit 2 may respond by changing PTZ zoom level, exposure, gain, shutter setting, illumination state, viewpoint, or a speed of the autonomous mobile platform 100, and may temporarily rely more heavily on whichever sensing modality remains informative while preserving continuity of the target estimate. By way of non-limiting example, if barcode decoding fails because of motion blur, the autonomous mobile platform 100 may pause, reduce motion, reorient, or approach to a closer verification distance; if LiDAR returns are sparse on a glossy surface, semantic-map constraints and image-derived geometry may continue to bound the spatial uncertainty region until an alternate confirmation opportunity is obtained.

In one exemplary moving-target implementation, the target is not stationary relative to the environment, such as a walking person, a moving cart, a forklift, a vessel, or an animal. In such a case, the processing unit 2 may time-stamp successive uncertainty regions, assign greater weight to more recent observations, and update the navigation waypoint to an intercept, follow, or observation pose rather than to a static centroid alone. The processing unit 2 may also distinguish between apparent target motion and apparent motion caused by movement of the autonomous mobile platform 100, PTZ actuation, or SLAM drift by comparing sequential observations against the current platform pose estimate and scene geometry. Even in this moving-target context, the disclosed architecture continues to operate by repeatedly generating bounded spatial uncertainty regions from image-based observations and by using those regions to guide platform motion and close-range confirmation.

In one exemplary identity-preservation implementation, the processing unit 2 stores not only a latest PTZ crop of the target but also one or more historical target representations collected during earlier successful observations. During later re-acquisition or handoff confirmation, the processing unit 2 may compare a candidate not only to the most recent appearance embedding but also to a rolling set of prior embeddings, templates, OCR strings, decoded identifiers, color attributes, or geometric descriptors. This may reduce the risk that a transiently similar distractor encountered near the destination is mistakenly accepted as the target. In one non-limiting example, a candidate may satisfy a class detector but still be rejected because a decoded serial number, text string, reference-image match, or cross-sensor similarity measure is inconsistent with the stored target history.

In one exemplary safety-constrained approach implementation, the selected navigation waypoint and the final arrival pose are further constrained by one or more operational safety rules, such as a minimum stand-off distance from humans, moving machinery, hazardous zones, high-temperature surfaces, energized equipment, stairs, ledges, or restricted areas represented in the semantic map or received from an external controller. Thus, the processing unit 2 may determine that the autonomous mobile platform 100 has arrived for task purposes even when the autonomous mobile platform 100 does not physically contact or occupy the exact target location, provided that the required handoff confirmation and arrival confirmation conditions are met at a safe task-capable pose. This embodiment may be particularly useful where the downstream action is imaging, OCR, barcode reading, thermal inspection, or remote observation rather than physical manipulation.

In one exemplary evidence-recording implementation, the processing unit 2 stores, for at least selected tasks, a mission record including one or more sweep images, enlarged PTZ images, target crops, confidence scores, spatial uncertainty regions or their parameters, waypoint updates, handoff results, arrival-confirmation results, and downstream action outputs. The stored mission record may support later human review, exception handling, fleet coordination, compliance documentation, or machine-learning improvement. In one non-limiting example, when the autonomous mobile platform 100 rejects a visually similar distractor or aborts a task because handoff confirmation fails, the corresponding record may preserve the negative evidence and the decision path that caused the system to remain in the VERIFYING state, return to the APPROACHING state, or transition to the RE-SEARCH state rather than prematurely declaring success.

In one exemplary temporal-consistency implementation, the processing unit 2 does not transition from the SEARCH state to the DETECTED state, from the APPROACHING state to the VERIFYING state, or from the VERIFYING state to the ARRIVED state based solely on a single instantaneous observation unless task parameters permit. Instead, the processing unit 2 may require that a candidate satisfy one or more consistency conditions across multiple successive frames, viewpoints, or sensor samples, such as repeated class agreement, repeated OCR or barcode agreement, bounded variation of projected target position in the semantic map, or repeated identity-consistency scores above threshold. Conversely, a temporary one-frame dropout or transient mismatch need not immediately cause target loss if neighboring observations (i.e., an immediate previous observation or an immediate later observation) remain mutually consistent. This embodiment may reduce false-positive lock-on and premature arrival declaration in cluttered or dynamic environments.

In one exemplary multi-hypothesis implementation, when multiple candidates remain plausible after coarse search, the processing unit 2 maintains a ranked candidate set to include the multiple candidates rather than collapsing immediately to a single candidate. Each candidate in the ranked candidate set may be associated with a confidence score, candidate representation, estimated uncertainty region, and a history of supporting or contradicting evidence. As additional PTZ observations or secondary-sensor observations are obtained, the processing unit 2 may promote, demote, merge, or discard any of the candidates in the ranked candidate set according to accumulated evidence until a selected candidate from among the candidates that remain in the ranked candidate set sufficiently satisfies the target description and downstream confirmation criteria. This embodiment may be useful in visually repetitive environments and may reduce wasted travel toward an early but weakly supported hypothesis.

In one exemplary map-evolution implementation, a prior semantic map or historical target location may indicate that an expected asset should be at a first position in the SLAM coordinate system, but current observations indicate that the asset has been moved, replaced, rotated, or partially reconfigured. The processing unit 2 may therefore treat information from the prior semantic map or the historical target location as a reference of prior location rather than as an absolute constraint, may expand or shift a search sector when the prior location is inconsistent with current evidence, and may update one or more stored task parameters after successful confirmation of the target at a new location in the SLAM coordinate system. In this manner, the disclosed system may remain effective even when inventory, equipment placement, or scene geometry changes over time, while still benefiting from previously learned map context.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for target search and autonomous guidance for an autonomous mobile platform, the autonomous mobile platform including a camera module, a range imaging module, at least one secondary sensor configured for close-range confirmation, an actuating module, a memory module storing a semantic three-dimensional map of an environment of the autonomous mobile platform, and a processing unit, the method being implemented by the processing unit and comprising:
receiving a search task containing a target description;
executing a hierarchical search procedure that includes
(a) controlling the camera module to perform a panoramic sweep at a wide-angle setting to capture a plurality of sweep images, and applying an object detection model to the plurality of sweep images to detect at least one candidate object, and
(b) for each of the at least one candidate object, controlling the camera module to adjust a focal length and a pointing direction to capture an enlarged image of the candidate object, where the adjusting is performed to improve an observation quality for subsequent uncertainty reduction, and applying at least one target identification method to the enlarged image to determine whether the candidate object matches the target description;
in response to determining that a target object among the at least one candidate object matches the target description, obtaining a candidate representation of the target object in the enlarged image captured by the camera module, where the candidate representation includes a plurality of observation points in an image coordinate system, and generating a spatial uncertainty region in a SLAM coordinate system of the semantic three-dimensional map by projecting the plurality of observation points from the image coordinate system into the SLAM coordinate system, and bounding the plurality of observation points thus projected using at least one depth limit to define, in the SLAM coordinate system, the spatial uncertainty region to be a three-dimensional uncertainty volume that forms a bounded geometric volume in which the target object is estimated to be located;
determining a navigation waypoint derived from the spatial uncertainty region;
controlling the actuating module to move the autonomous mobile platform toward the navigation waypoint while iteratively performing re-acquisition of the target object using the camera module, where each re-acquisition includes directing the camera module toward an expected target direction, selectively adjusting a focal length or an observation direction of the camera module to improve the observation quality for uncertainty reduction, capturing another enlarged image, detecting the target object in the another enlarged image, obtaining an updated candidate representation of the target object in the another enlarged image, generating an updated spatial uncertainty region from the updated candidate representation, and refining the spatial uncertainty region that is generated based on the plurality of observation points of the candidate representation in the enlarged image by combining the updated spatial uncertainty region with the spatial uncertainty region previously computed according to a reduction criterion based on geometric information from successive observations of the target object taken from distinct observation viewpoints, wherein the reduction criterion reduces a spatial extent of the spatial uncertainty region by constraining at least one of region boundaries, angular bounds, or depth bounds of the spatial uncertainty region;
in response to a proximity condition associated with the spatial uncertainty region being satisfied, performing a sensor handoff confirmation by initiating a transition from the camera module to the at least one secondary sensor, and evaluating whether the target object is detected by the at least one secondary sensor and meets at least one of a plurality of threshold conditions, where the plurality of threshold conditions includes an identity-consistency threshold requiring correspondence between a camera-module-based target representation and a secondary-sensor target representation; and
determining that the autonomous mobile platform has arrived at the target object in response to determining that the sensor handoff confirmation is successful, and that at least one arrival confirmation condition is satisfied, wherein the arrival confirmation condition is selected from (i) a target-occupancy condition, (ii) a sensor-confirmation condition, (iii) a distance condition, or (iv) a combined condition requiring at least two of conditions (i) through (iii) to be simultaneously satisfied.

2. The method of claim 1, the autonomous mobile platform further including an input module and a communication module, wherein the search task is received from at least one of: a user command via the input module, a scheduled periodic task retrieved from a task schedule, an upstream controller via the communication module, and a voice command processed through speech-to-text and natural language understanding.

3. The method of claim 2, wherein the user command is a natural language command including a target description of the target object, and the processing unit uses a language model to extract the target description from the natural language command.

4. The method of claim 1, wherein the at least one target identification method includes applying a trained deep learning classification model to the enlarged image.

5. The method of claim 1, the autonomous mobile platform storing a reference image corresponding to an object category, wherein the at least one target identification method includes performing a reference image matching by extracting a plurality of first visual features from the enlarged image and a plurality of second visual features from the reference image using feature descriptor algorithms, and determining whether the candidate object matches the reference image based on feature correspondence.

6. The method of claim 1, wherein the at least one target identification method includes inputting the enlarged image and text of the target description to a Vision Language Model (VLM) that outputs a confidence score indicating whether the enlarged image matches the target description.

7. The method of claim 1, wherein the at least one target identification method includes using a few-shot learning model with a plurality of example images of the target object to recognize the object category of the candidate object.

8. The method of claim 1, further comprising applying at least two target identification methods to the enlarged image for respectively obtaining at least two confidence scores, and fusing the at least two confidence scores obtained respectively from the at least two target identification methods using a fusion technique to determine whether the candidate object is to enter an uncertainty-bounded guidance loop.

9. The method of claim 1, wherein the spatial uncertainty region is an uncertainty volume defined as a convex hull of points computed by evaluating a plurality of projection rays at a near depth limit and a far depth limit, the plurality of projection rays are computed for at least four corners of a bounding box of the candidate representation using an inverse of the camera intrinsic matrix, and the near depth limit and the far depth limit are obtained from at least one of: direct range measurements from the range imaging module, semantic-map constraints, known surfaces in the environment, and geometric priors.

10. The method of claim 1, wherein the at least one of the plurality of threshold conditions evaluated during sensor handoff confirmation are selected from: a target-occupancy threshold, a detection-confidence threshold, an OCR-readability threshold, a barcode-decodability threshold, a point-cloud-density threshold, a target-distance-consistency threshold, an identity-consistency threshold, and a task-specific quality threshold.

11. The method of claim 10, wherein in response to failing the sensor handoff confirmation for a maximum number of consecutive handoff attempts, the processing unit transitions to a re-search state.

12. The method of claim 10, the at least one secondary sensor being configured to obtain secondary sensor data, wherein the identity-consistency threshold used in sensor handoff confirmation requires that a similarity metric computed between an appearance embedding extracted from the enlarged image of the target object and a corresponding representation extracted from the secondary sensor data exceeds the identity-consistency threshold, and wherein the similarity metric is evaluated using one of cosine similarity, feature-space distance, template match score, and another correspondence metric.

13. The method of claim 1, further comprising:
in response to the re-acquisition of the target object failing for a maximum number of consecutive re-acquisition attempts during an approach state, recording a last known position of the target object in the semantic three-dimensional map, moving the autonomous mobile platform to a vantage point selected based on at least one of: obstacle bypass, line-of-sight recovery to a last known target direction, and an uncertainty-region visibility score, and performing a targeted search in a vicinity of the last known target position using a last computed spatial uncertainty region to narrow a search area.

14. The method of claim 1, wherein the method is managed by a state machine with a plurality of states including an IDLE state, a SEARCH state, a DETECTED state, an APPROACHING state, a RE-SEARCH state, a VERIFYING state, an ARRIVED state, and an EXECUTING state, with defined transition conditions between the plurality of states, wherein a transition from the APPROACHING state to the VERIFYING state is triggered by at least one pre-arrival trigger condition, and a transition from the VERIFYING state to the ARRIVED state requires successful sensor handoff confirmation and satisfaction of the at least one arrival confirmation condition.

15. The method of claim 1, wherein refining the spatial uncertainty region includes computing a geometric intersection of the updated spatial uncertainty region and the previously computed spatial uncertainty region to produce a refined spatial uncertainty region having a reduced spatial extent compared to the previously computed spatial uncertainty region.

16. The method of claim 15, wherein in response to the geometric intersection being empty or falling below a minimum overlap criterion, the processing unit applies a fallback strategy selected from: computing a confidence-weighted union of the updated spatial uncertainty region and the previously computed spatial uncertainty region, relaxing at least one of the depth bounds or the angular bounds and re-computing the geometric intersection, retaining one of the updated spatial uncertainty region and the previously computed spatial uncertainty region that is associated with a higher confidence score, or reverting to a re-search procedure.

17. The method of claim 1, the camera module being configured as a pan-tilt-zoom (PTZ) camera, the method further comprising selecting a camera control action for controlling the camera module based on a measure of a spatial uncertainty associated with the spatial uncertainty region, wherein the camera control action includes at least one of:
adjusting a focal length of the camera module to reduce an angular extent of the spatial uncertainty region, and selecting an observation direction of the camera module that increases an angular baseline relative to previous observations to reduce the spatial uncertainty upon subsequent re-acquisition of the target object.

18. The method of claim 1, the camera module being configured as a pan-tilt-zoom (PTZ) camera, wherein the spatial uncertainty region includes a bounded geometric volume having the angular bounds and the depth bounds that are derived from geometric projection of the plurality of observation points in the image coordinate system to the SLAM coordinate system using a camera intrinsic matrix, a pan angle and a tilt angle of the camera module, and an estimated pose of the autonomous mobile platform from a SLAM (Simultaneous Localization and Mapping) algorithm.

19. The method of claim 1, wherein determining the navigation waypoint further includes selecting or updating intermediate waypoints to maintain line-of-sight visibility of the target object during approach by analyzing any occluding obstacles in the semantic three-dimensional map.

20. An autonomous mobile platform system comprising:
an actuating module configured to move the autonomous mobile platform through an environment;
a camera module configured as a pan-tilt-zoom (PTZ) camera, where the camera module has a motorized pan actuator, a motorized tilt actuator, and a plurality of lens with variable focal lengths;
a range imaging module configured to provide one of a depth measurement and a range measurement;
at least one secondary sensor configured for close-range confirmation;
a memory module configured to store a semantic three-dimensional map of an environment of the autonomous mobile platform; and
a processing unit communicatively connected to the actuating module, the camera module, the range imaging module, and the at least one secondary sensor, and configured to
execute a hierarchical search procedure to detect and identify a target object using the camera module, where the hierarchical search procedure includes adjusting a focal length and a pointing direction of the camera module to improve an observation quality for uncertainty reduction;
generate a spatial uncertainty region corresponding to the target object by projecting a plurality of observation points of a candidate representation of the target object in an image coordinate system to a SLAM coordinate system of the semantic three-dimensional map using camera intrinsic matrix, a pan angle and a tilt angle of the camera module, and an estimated pose of the autonomous mobile platform from a SLAM (Simultaneous Localization and Mapping) algorithm, and bounding the plurality of observation points thus projected using at least one depth limit to define, in the SLAM coordinate system, the spatial uncertainty region to be a bounded geometric volume;
determine a navigation waypoint derived from the spatial uncertainty region;
control the actuating module to move the autonomous mobile platform toward the navigation waypoint while iteratively performing re-acquisition of the target object, refining the spatial uncertainty region that is generated based on the plurality of observation points of the candidate representation by combining an updated spatial uncertainty region with the spatial uncertainty region previously computed according to a reduction criterion based on geometric information from successive observations of the target object taken from distinct observation viewpoints, wherein the reduction criterion reduces a spatial extent of the spatial uncertainty region by constraining one or more region boundaries, angular bounds, or depth bounds of the spatial uncertainty region;
in response to a proximity condition associated with the spatial uncertainty region being satisfied, perform a sensor handoff confirmation by transitioning from the camera module to the at least one secondary sensor, and evaluate whether the target object meets at least one of a plurality of threshold conditions, where the plurality of threshold conditions includes an identity-consistency condition requiring correspondence between a camera-module-based target representation and a secondary-sensor target representation; and
determine that the autonomous mobile platform has arrived at the target object in response to determining that the sensor handoff confirmation is successful and that at least one arrival confirmation condition is satisfied, wherein the arrival confirmation condition is selected from: i) a target-occupancy condition, ii) a sensor-confirmation condition, iii) a distance condition, or iv) a combined condition requiring at least two of conditions i) through iii) to be simultaneously satisfied.

21. The system of claim 20, further comprising at least one fixed field-of-view camera for wide-angle observation and obstacle avoidance.

22. The system of claim 20, further comprising an input module configured to receive a search task in a form of one of a natural language text and a voice input, and a communication module configured to receive a search task from an upstream controller.

23. The system of claim 20, wherein the processing unit further implements a state machine that manages a plurality of states including an IDLE state, a SEARCH state, a DETECTED state, an APPROACHING state, a RE-SEARCH state, a VERIFYING state, an ARRIVED state, and an EXECUTING state, with defined transition conditions between the plurality of states.

24. A method for multi-modal target identification and uncertainty-guided control on an autonomous mobile platform, the autonomous mobile platform including a camera module configured as a pan-tilt-zoom (PTZ) camera, at least one secondary sensor configured for close-range confirmation, and a processing unit, the method being implemented by the processing unit and comprising:
receiving a target description indicating a target object;
receiving, from the camera module that has performed a camera-module-based coarse search in which a panoramic sweep is performed with an object detection model, a detection of at least one candidate object;
for each of the at least one candidate object, controlling the camera module to reorient toward the candidate object and capture an enlarged image of the candidate object by adjusting a focal length and a pointing direction toward the candidate object, where the adjusting is performed to improve an observation quality for uncertainty reduction;
applying at least two target identification methods to the enlarged image to determine whether the candidate object matches the target object indicated in the target description, where the at least two target identification methods are selected from: a) a trained deep learning classification model, b) a reference image matching using feature descriptor algorithms, c) a Vision Language Model that accepts image and text as input, and d) a few-shot learning model using a plurality of example images of the target object;
for each of the at least two target identification methods that has been applied, obtaining a confidence score;
fusing at least two confidence scores obtained respectively from the at least two target identification methods using one of weighted averaging, max-pooling, voting, or a learned fusion function to produce a combined confidence score;
determining whether the candidate object matches the target description based on whether the combined confidence score exceeds a match threshold;
upon determining that the candidate object matches the target description, generating a spatial uncertainty region corresponding to the target object by projecting a plurality of observation points of an image-based representation of the candidate object in an image coordinate system to a SLAM coordinate system of a semantic three-dimensional map using a camera intrinsic matrix, a pan angle and a tilt angle of the camera module, and an estimated pose of the autonomous mobile platform from a SLAM (Simultaneous Localization and Mapping) algorithm, and bounding the plurality of observation points thus projected using at least one depth limit to define, in the SLAM coordinate system, the spatial uncertainty region to be a three-dimensional uncertainty volume that forms a bounded geometric volume;
controlling at least one of the camera module of the autonomous mobile platform to perform a subsequent re-acquisition of the target object that improves the observation quality for uncertainty reduction and refining the spatial uncertainty region by combining an updated spatial uncertainty region with the spatial uncertainty region previously computed according to a reduction criterion based on geometric information from successive observations of the target object taken from distinct observation viewpoints, wherein the reduction criterion reduces a spatial extent of the spatial uncertainty region by constraining at least one of region boundaries, angular bounds, or depth bounds of the spatial uncertainty region; and
in response to a proximity condition associated with the spatial uncertainty region being satisfied, performing a sensor handoff confirmation by initiating close-range confirmation using the at least one secondary sensor, and evaluating whether the candidate object is detected by the at least one secondary sensor and meets at least one of a plurality of threshold conditions, where the plurality of threshold conditions includes an identity-consistency condition requiring correspondence between a camera-module-based target representation and a secondary-sensor target representation.

25. The method of claim 24, wherein the few-shot learning model is adapted using one to ten example images of the target object, where the one to ten example images are provided by a user at a start of a search task.

26. A method for uncertainty-bounded guidance of an autonomous mobile platform toward a target detected by a pan-tilt-zoom (PTZ) camera, the target being captured in a PTZ image which is obtained by the PTZ camera, the autonomous mobile platform including at least one secondary sensor configured for close-range confirmation, an actuating module, and a processing unit, the method being implemented by the processing unit and comprising:
obtaining a candidate representation of the target in the PTZ image;
generating a spatial uncertainty region corresponding to the target in a SLAM coordinate system by projecting a plurality of observation points of the candidate representation from an image coordinate system of the PTZ image to the SLAM coordinate system using a camera intrinsic matrix, a pan angle and a tilt angle of the PTZ camera, and an estimated pose of the autonomous mobile platform from a SLAM (Simultaneous Localization and Mapping) algorithm, wherein the spatial uncertainty region is bounded by a near depth limit and a far depth limit to define a three-dimensional uncertainty volume that forms a bounded geometric volume representing an estimated target location of the target;
selecting a navigation waypoint derived from the spatial uncertainty region, where the navigation waypoint is a traversable point selected based on at least one of a centroid of the three-dimensional uncertainty volume, a nearest traversable point, a point preserving line-of-sight visibility to the target object from the autonomous mobile platform, and a task-specific approach pose;
iteratively, moving the autonomous mobile platform for an incremental distance toward the navigation waypoint using the actuating module, re-acquiring the target by directing the PTZ camera, selectively adjusting one of a focal length and an observation direction of the PTZ camera to improve an observation quality for uncertainty reduction, and capturing a new image, obtaining an updated candidate representation, generating an updated spatial uncertainty region, refining the spatial uncertainty region representing the estimated target location of the target by combining the updated spatial uncertainty region with the spatial uncertainty region previously computed according to a reduction criterion based on geometric information from successive observations of the target taken from distinct observation viewpoints, wherein the reduction criterion reduces a spatial extent of the spatial uncertainty region by constraining at least one of region boundaries, angular bounds, or depth bounds of the spatial uncertainty region, and updating the navigation waypoint based on the spatial uncertainty region thus refined;
in response to a proximity condition associated with the spatial uncertainty region being satisfied, performing a sensor handoff confirmation by initiating use of the at least one secondary sensor, and evaluating whether the at least one secondary sensor detects the target and meets at least one of a plurality of threshold conditions, where the plurality of threshold conditions includes an identity-consistency threshold requiring cross-sensor correspondence between a PTZ-based target representation and a secondary-sensor target representation; and
determining arrival of the autonomous mobile platform in response to determining that the sensor handoff confirmation is successful, and that at least one arrival confirmation condition is satisfied, wherein the arrival confirmation condition is selected from i) a target-occupancy condition, ii) a sensor-confirmation condition, iii) a distance condition, or iv) a combined condition requiring at least two of conditions i) through iii) to be simultaneously satisfied.

27. The method of claim 26, wherein the processing unit recomputes the navigation waypoint from the spatial uncertainty region that is refined at each iteration, such that the navigation waypoint is updated to reduce a spatial extent of the spatial uncertainty region as the autonomous mobile platform approaches the target.

28. The method of claim 26, further comprising: in response to the re-acquisition of the target failing for a maximum number of consecutive re-acquisition attempts, transitioning to a re-search procedure, which includes moving the autonomous mobile platform to a new vantage point and performing a targeted search in a vicinity of a last known target position using the spatial uncertainty region last computed to narrow a search area.

29. The method of claim 26, wherein the processing unit selects at least one of a PTZ camera configuration and a platform navigation waypoint to maximize expected reduction in the spatial uncertainty region upon a subsequent re-acquisition, based on angular baseline relative to previous observations.

30. The method of claim 26, wherein the identity-consistency threshold requires that a similarity metric computed between a PTZ-based appearance representation of the target and a corresponding representation extracted from secondary sensor data exceeds a minimum consistency threshold, and wherein the similarity metric is evaluated using one of cosine similarity, feature-space distance, template match score, and another correspondence metric.
